(19) United States
(12) Patent Application Publication
(10) Pub. No.: US 2014/0198868 A1
(43) Pub. Date: Jul. 17, 2014

(54) DL MIMO Precoding Enhancement

(71) Applicant: Nokia Solutions and Networks Oy, Espoo (FI)

(72) Inventors: Weidong Yang, Hoffman Estates, IL (US); Timo E. Lunttila, Espoo (FI)

(73) Assignee: Nokia Solutions and Networks Oy, Espoo (FI)

(21) Appl. No.: 14/158,035

(22) Filed: Jan. 17, 2014

Related U.S. Application Data
(60) Provisional application No. 61/753,663, filed on Jan. 17, 2013.

(51) Int. Cl. H04B 7/04

(52) U.S. Cl. CPC H04B 7/0456
USPC 375/267

(57) ABSTRACT

A method includes applying a precoder to information to be transmitted on N antenna ports, wherein application of the precoder creates an M-Tx codebook, each codeword of which is obtained through truncation of a codeword from an N-Tx codebook corresponding to the N antenna ports. The precoded information is transmitted on the N antenna ports to a UE and information allowing an N-Tx codeword to be selected from the N-Tx codebook is received. The N-Tx codeword is truncated to an M-Tx codeword and the M-Tx codeword is used for a transmission to the UE. Another method includes receiving at a UE a transmission in first and second sets of N antenna ports, wherein the second set of antenna ports creates at least in part an M-Tx codebook. The UE searches the N-Tx codebook to determine an N-Tx codeword to be fed back and feeds back the N-Tx codeword.

### CROSS-REFERENCE TO RELATED APPLICATIONS

The present application claims the benefit under 35 U.S.C. §119(e) of U.S. Provisional Patent Application No. 61/753,663, filed on Jan. 17, 2013, the disclosure of which is hereby incorporated by reference in its entirety.

### TECHNICAL FIELD

This invention relates generally to wireless communication and, more specifically, relates to downlink (DL) multiple-in, multiple-out (MIMO) precoding.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below at the end of the specification but prior to the claims.

In broad terms, PDSCH transmission modes use precoding from a defined “codebook” to form transmission layers (e.g., transmitted from an eNB to a UE). Each codebook comprises a set of predefined precoding matrices (where an n×1 vector can be treated as an n×1 matrix). Generally, a codebook is a catalog of precoding matrices, and each precoding matrix is fully specified by its rank and an index. PMI (Precoding Matrix Indicator) is the index of the precoding matrix, so there is a one-to-one mapping between a precoding matrix and PMI at a given rank. From LTE Release 10 onwards, an eNB, which is an LTE base station, can transmit CSI-RS signals from its antenna ports. The eNB transmits the CSI-RS in DL to the UE at one or more subframes. The UE determines which codeword (e.g., matrix) is the most desirable (e.g., would maximize throughput relative to the other codewords) and feeds back an indication of this codeword to the eNB and the channel quality indicator (CQI) the UE would see if the eNB transmits with the precoding matrix that has been fed back. So, from the rank indicator (RI) and PMI feedback, the preferred matrix by the UE is known by eNB. It is noted that additional description for multiple antenna techniques, including downlink reference signals, may be found in Gorkhov et al., “Multiple Antenna Techniques for LTE Advanced”, Ch. 29 of “LTE: The UMTS Long Term Evolution”, pages 651-671.

Codebook design has attracted great interest since the beginning of LTE. In Releases 8 and 10, codebooks were studied and debated. UE complexity and deployment scenarios have been important factors in selecting the codebooks. As changes in the codebook inevitably leads to changes in UE implementation, understandably RAN1 has been treating codebook proposals with extreme care. RAN1 is a 3GPP specification group responsible for specification of the physical layer of the radio interface for a UE, UTRAN, Evolved UTRAN, and beyond. RAN1 have repeatedly found from codebook design exercises, that the performance of a codebook often depends on the deployment scenario: ULA versus cross-polarization, and the like. As a consequence, the LTE codebook is a compromise for all deployment scenarios. It is fair to assume, for each particular scenario, further optimization of the current LTE codebook would be possible, yet it is not clear how deployment scenarios should be prioritized—the ranking of the scenarios can be highly subjective.

The 8-Tx codebook was introduced in Rel-10. There are some salient points about the 8-Tx codebook and its use: great resolution, two-stage feedback, and the like.

In the further DL MIMO enhancement work item in 3GPP Release 12, a new codebook was introduced to enhance the throughput performance for both 4-Tx antenna configurations. Two antenna configurations which were prioritized were closely spaced two cross-pol (cross-polarized) antenna pairs (e.g., spaced by 0.5 wavelength) and widely spaced two cross-pol antenna pairs (e.g., spaced by 4 or 10 wavelengths).

It is beneficial to explore techniques other than standardization of a completely new codebook for Rel-12 and the like.

### SUMMARY

This section contains examples of possible implementations and is not meant to be limiting.

An exemplary embodiment is a method comprising: applying a precoder to information to be transmitted on N antenna ports, wherein application of the precoder to the information creates at least in part an M-Tx codebook, each codeword of which is obtained through truncation of a codeword from an N-Tx codebook corresponding to the N antenna ports; transmitting the precoded information on the N antenna ports; receiving, responsive to the transmission and from the user equipment, information allowing an N-Tx codeword to be selected from the N-Tx codebook; truncating, based at least on the precoder, the N-Tx codeword to an M-Tx codeword; and using the M-Tx codeword for a transmission of information to the user equipment.

Another exemplary embodiment is a method as above, wherein: the information comprise reference signals; applying a precoder selects a first set of M of the N antenna ports to be energized during a transmission to a user equipment and a second set of P of the N antenna ports to not be energized during the transmission, N=M+P, wherein the antenna ports that are not energized create at least in part an M-Tx codebook, each codeword of which is obtained through truncation of a codeword from an N-Tx codebook corresponding to the N antenna ports; transmitting further comprises transmitting reference signals with non-zero power on the first set of antenna ports and not transmitting signals on the second set of antenna ports; receiving further comprises receiving, responsive to the transmission and from the user equipment, information allowing an N-Tx codeword to be selected from the N-Tx codebook; and truncating further comprises truncating, based at least on the second set of P antenna ports, the N-Tx codeword to an M-Tx codeword.

A method as above, wherein one of the following is true: M is two and a number of the first set of antenna ports to be energized is two, P is two and a number of the second antenna ports to not be energized is two, and N is four; or M is four and a number of the first set of antenna ports to be energized is four, P is four and a number of the second set of antenna ports to not be energized is four, and N is eight.

A method as above, wherein: the information comprise reference signals; applying a precoder selects a first set of M of N antenna ports to transmit first reference signals during a transmission to a user equipment and a second set of M of the N antenna ports to duplicate the first reference signals during the transmission, wherein duplication of the first reference signals creates at least in part the M-Tx codebook; transmitting further comprises transmitting the first reference signals with non-zero power on the first set of antenna ports and transmitting duplicate reference signals with non-zero power on the second set of antenna ports; and receiving further comprises receiving, responsive to the transmission and from the user equipment, information allowing an N-Tx codeword to be selected from the N-Tx codebook; and truncating further comprises truncating, based at least on the duplication of the first reference signals, the N-Tx codeword to an M-Tx codeword.

A method as above, wherein one of the following is true: M is two, a number of the first set of antenna ports to transmit the first signals is two, a number of the second antenna ports to duplicate the first signals is two, and N is four; or M is four, a number of the first set of antenna ports to transmit the first signals is four, a number of the second antenna ports to duplicate the first signals is four, and N is eight.

A method as above, further comprising obtaining a 4-Tx codebook from an 8-Tx codebook, at least by using one or more of the following techniques: performing permutation of a logical port index to physical antenna index mapping; using different puncturing patterns for energizing or not energizing selected ones of the antenna ports; applying a phase rotation on the energized antenna ports.

A method as above, further comprising, prior to transmitting, sending one or more indications selecting which codebook indices in the N-Tx codebook should be searched by the user equipment, wherein the selected codebook indices are less than all of the indices in the N-Tx codebook.

Another exemplary embodiment is a method comprising: receiving at a user equipment a transmission of first signals in a first set of N antenna ports and of second signals in a second set of the N antenna ports, wherein the second signals in the second set of antenna ports create at least in part an M-Tx codebook; searching by the user equipment the N-Tx codebook to determine an N-Tx codeword to be fed back; and transmitting by the user equipment information to allow the N-Tx codeword to be determined.

A method as above, wherein: the first signals are reference signals; and receiving comprises receiving reference signals with non-zero power in the first set of M of the N antenna ports and receiving the second signals in the second set of P of the N antenna ports upon which signals were not sent for the transmission, N=M+P, wherein the P antenna ports upon which signals were not sent create at least in part the M-Tx codebook.

A method as above, wherein one of the following is true: M is two and a number of the first set of antenna ports with non-zero power is two, P is two and a number of the second antenna ports upon which signals were not sent is two, and N is four; or M is four and a number of the first set of antenna ports with non-zero power is four, P is four and a number of the second antenna ports upon which signals were not sent is four, and N is eight.

A method as above, wherein: the method further comprises, prior to receiving, receiving one or more indications selecting which codebook indices in the N-Tx codebook should be searched by the user equipment, wherein the selected codebook indices are less than all of the indices in the N-Tx codebook; and searching further comprises searching only the selected codebook indices in the N-Tx codebook to determine an N-Tx codeword to be fed back.

A method as above, wherein: the first signals are first reference signals; the second signals are second reference signals; and receiving further comprises receiving the first reference signals with non-zero power in the first set M of N antenna ports and second reference signals with non-zero power, in the second set M of the N antenna ports, that are duplicates of the first reference signals, wherein duplication of the first reference signals on the second set of antenna ports creates at least in part the M-Tx codebook.

A method as above, wherein searching comprises searching by the user equipment a subset that is less than all of the N-Tx codebook to determine a codeword to be fed back, wherein the subset of the codebook corresponds to the first set of antenna ports and not to the second set of antenna ports.

A method as above, wherein one of the following is true: M is two, a number of the first set of antenna ports with non-zero power is two, a number of the second antenna ports upon which signals were not sent is two, and N is four; or M is four, a number of the first set of antenna ports with non-zero power is four, a number of the second antenna ports upon which signals were not sent is four, and N is eight.

A method as above, wherein: the method further comprises, prior to receiving, receiving one or more indications selecting which codebook indices in the N-Tx codebook should be searched by the user equipment, wherein the selected codebook indices are less than all of the indices in the N-Tx codebook; and searching further comprises searching only the selected codebook indices in the N-Tx codebook to determine an N-Tx codeword to be fed back.

A method as above, further comprising after transmitting receiving at the user equipment a transmission based on an M-Tx codeword that is a truncated version of the transmitted N-Tx codeword.

A further exemplary embodiment is an apparatus comprising means for performing any of the methods above.

Another exemplary embodiment is an apparatus, comprising: means for applying a precoder to information to be transmitted on N antenna ports, wherein application of the precoder to the information creates at least in part an M-Tx codebook, each codeword of which is obtained through truncation of a transformed codeword from an N-Tx codebook corresponding to the N antenna ports; means for transmitting the precoded information on the N antenna ports; means for receiving, responsive to the transmission and from the user equipment, information allowing an N-Tx codeword to be selected from the N-Tx codebook; means for truncating, based at least on the precoder, the N-Tx codeword to an M-Tx codeword; and means for using the M-Tx codeword for a transmission of information to the user equipment.

The apparatus of the previous paragraph, wherein: the information comprise reference signals; the means for applying a precoder selects a first set of M of the N antenna ports to be energized during a transmission to a user equipment and a second set of P of the N antenna ports to not be energized during the transmission, N=M+P, wherein the antenna ports that are not energized create at least in part an M-Tx codebook, each codeword of which is obtained through truncation of a codeword from an N-Tx codebook corresponding to the N antenna ports; the means for transmitting further comprises means for transmitting reference signals with non-zero power on the first set of antenna ports and not transmitting signals on the second set of antenna ports; the means for receiving further comprises means for receiving, responsive to the transmission and from the user equipment, information allowing an N-Tx codeword to be selected from the N-Tx codebook; and the means for truncating further comprises means for truncating, based at least on the second set of P antenna ports, the N-Tx codeword to an M-Tx codeword. The apparatus of the previous paragraph, wherein: the information comprise reference signals; the means for applying a precoder selects a first set of M of N antenna ports to transmit first reference signals during a transmission to a user equipment and a second set of M of the N antenna ports to duplicate the first reference signals during the transmission, wherein duplication of the first reference signals creates at least in part the M-Tx codebook; the means for transmitting further comprises means for transmitting the first reference signals with non-zero power on the first set of antenna ports and transmitting duplicate reference signals with non-zero power on the second set of antenna ports; and the means for receiving further comprises means for receiving, responsive to the transmission and from the user equipment, information allowing an N-Tx codeword to be selected from the N-Tx codebook; and the means for truncating further comprises means for truncating, based at least on the duplication of the first reference signals, the N-Tx codeword to an M-Tx codeword. A further exemplary embodiment is a base station comprising any of the apparatus of the previous two paragraphs.

Yet another exemplary embodiment is an apparatus, comprising: means for receiving at a user equipment a transmission of first signals in a first set of N antenna ports and of second signals in a second set of the N antenna ports, wherein the second signals in the second set of antenna ports create at least in part an M-Tx codebook; means for searching by the user equipment the N-Tx codebook to determine an N-Tx codeword to be fed back; and means for transmitting by the user equipment information to allow the N-Tx codeword to be determined.

An apparatus as in the previous paragraph, wherein: the first signals are reference signals; the means for receiving comprises means for receiving reference signals with non-zero power in the first set of M of the N antenna ports and receiving the second signals in the second set of P of the N antenna ports upon which signals were not sent for the transmission, N=M+P, wherein the P antenna ports upon which signals were not sent create at least in part the M-Tx codebook. An apparatus as in the previous paragraph, wherein: the first signals are first reference signals; the second signals are second reference signals; and the means for receiving further comprises means for receiving the first reference signals with non-zero power in the first set M of N antenna ports and second reference signals with non-zero power, in the second set M of the N antenna ports, that are duplicates of the first reference signals, wherein duplication of the first reference signals on the second set of antenna ports creates at least in part the M-Tx codebook.

Yet another exemplary embodiment is a communication system comprising one or more of the apparatus as above.

An additional exemplary embodiment is a computer program comprising program code for executing the method according to any of the methods above. A computer program according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform at least the following: applying a precoder to information to be transmitted on N antenna ports, wherein application of the precoder to the information creates at least in part an M-Tx codebook, each codeword of which is obtained through truncation of a codeword from an N-Tx codebook corresponding to the N antenna ports; transmitting the precoded information on the N antenna ports; receiving, responsive to the transmission and from the user equipment, information allowing an N-Tx codeword to be selected from the N-Tx codebook; truncating, based at least on the precoder, the N-Tx codeword to an M-Tx codeword; and using the M-Tx codeword for a transmission of information to the user equipment.

An exemplary apparatus includes one or more processors and one or more memories including computer program code. The one or more memories and the computer program code are configured to, with the one or more processors, cause the apparatus to perform at least the following: receiving at a user equipment a transmission of first signals in a first set of N antenna ports and of second signals in a second set of the N antenna ports, wherein the second signals in the second set of antenna ports create at least in part an M-Tx codebook; searching by the user equipment the N-Tx codebook to determine an N-Tx codeword to be fed back; and transmitting by the user equipment information to allow the N-Tx codeword to be determined.

### BRIEF DESCRIPTION OF THE DRAWINGS

In the attached Drawing Figures:

FIG. 1 is a block diagram of an exemplary system in which the exemplary embodiments may be practiced;

FIG. 2 illustrates use of 4-Tx codebook for a 2-Tx transmission;

FIG. 3 illustrates a 2-Tx codebook, where the rank 1 codewords are indicated;

FIG. 4 illustrates a 4-Tx codebook, where the rank 1 codewords are indicated;

FIG. 5 illustrates port phase differences with respect to port 15 for rank 1 codewords in a current LTE 4-Tx codebook; for use for 2-TX operation, it is sufficient to restrict the codebook to indices W0 . . . W7 only;

FIG. 6 illustrates an exemplary use of an 8-Tx codebook for 4-Tx transmission, where some of the 8 CSI-RS antenna ports are not energized;

FIGS. 7A-7D are a table illustrating 128 rank=1 codewords with restriction for an exemplary embodiment;

FIG. 8 illustrates another exemplary use of an 8-Tx codebook for 4-Tx transmission, where some of the 8 CSI-RS antenna ports are not energized;

FIGS. 9A-9D are a table illustrating 128 rank=1 codewords with restriction for another exemplary embodiment;

FIG. 10 illustrates yet another exemplary use of an 8-Tx codebook for 4-Tx transmission, where some of the 8 CSI-RS antenna ports are not energized; and

FIGS. 11-16 are logic flow diagrams illustrating the operation of an exemplary method, a result of execution of computer program instructions embodied on a computer readable memory, and/or functions performed by logic implemented in hardware, in accordance with exemplary embodiments.

### DETAILED DESCRIPTION OF THE DRAWINGS

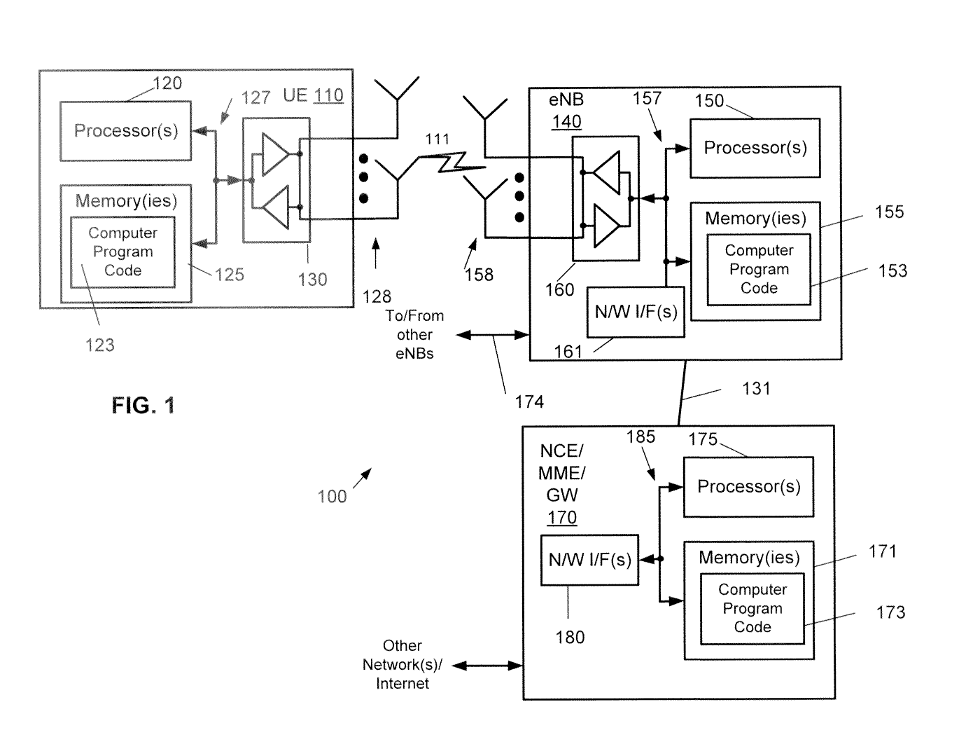

Before proceeding with additional description of problems and solutions herein to those problems, reference is made to FIG. 1, which shows a block diagram of an exemplary system in which the exemplary embodiments may be practiced. In FIG. 1, a UE 110 is in wireless communication with a network 100. The user equipment 110 includes one or more processors 120, one or more memories 125, and one or more transceivers 130 interconnected through one or more buses 127. The one or more transceivers 130 are connected to one or more antennas 128. The one or more memories 125 include computer program code 123. The one or more memories 125 and the computer program code 123 are configured to, with the one or more processors 120, cause the user equipment 110 to perform one or more of the operations as described herein. The UE 110 communicates with eNB 220 via link 111.

The eNB 140 includes one or more processors 150, one or more memories 155, one or more network interfaces (N/W I/F(s)) 161, and one or more transceivers 160 interconnected through one or more buses 157. The one or more transceivers 160 are connected to one or more antennas 158. The one or more memories 155 include computer program code 153. The one or more memories 155 and the computer program code 153 are configured to, with the one or more processors 150, cause the eNB 140 to perform one or more of the operations as described herein. The one or more network interfaces 161 communicate over a network such as the networks 174 and 131. Two or more eNBs 140 communicate using, e.g., network 174. The network 174 may be wired or wireless or both and may implement, e.g., an X2 interface.

The wireless network 100 may include a network control element (NCE) 170 that may include MME/SGW functionality, and which provides connectivity with a further network, such as a telephone network and/or a data communications network (e.g., the Internet). The eNB 140 is coupled via a network 131 to the NCE 170. The network 131 may be implemented as, e.g., an S1 interface. The NCE 170 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 170 to perform one or more operations.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The processors 120, 150, and 175 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments of the user equipment 110 can include, but are not limited to, cellular telephones such as smart phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

As stated above, one technique for enhancing the current 4-Tx codebook is to standardize a completely new codebook. This is a very time consuming exercise, involves significant implementation effort, and provides benefits for UEs and networks only from LTE release 12 onwards (2015+). In this disclosure, implementation-specific approaches and reduced specification impact approaches are disclosed to enhance LTE feedback accuracy for a system operating with 2 or 4 transmit antenna ports. For instance, certain exemplary embodiments reuse 8-Tx codebooks for 4-Tx, which leverages all the previous work built for 8-Tx; and other exemplary embodiments reused 4-Tx codebooks for 2-Tx which leverages all the previous work built for 4-Tx. Certain solutions according to the exemplary embodiments herein are already available for Rel-10 networks and UEs and require basically no additional standardization. The underlying designed principle can be extended to more cases as given below.

From simulation results from a study item stage, respectable gains were shown with a dual codebook structure. Hence, it is interesting to consider the following idea: a 4-Tx or 2-Tx LTE system is configured with 8 or 4 port CSI-RS, respectively, and a Rel-10 8-Tx (or 4-Tx) codebook is used. Additionally, codebook subset restriction may be used to reduce codeword search effort.

For ease of reference, the instant disclosure is separated into multiple sections. Section 1 follows.

### Section 1

### Using 4-Tx Codebook for 2-Tx Transmission with Puncturing

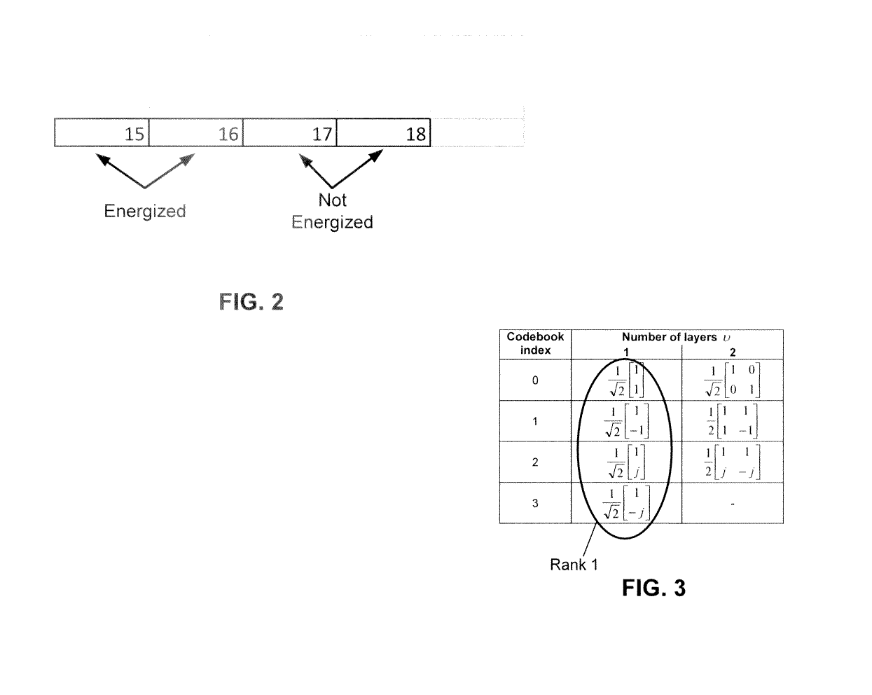

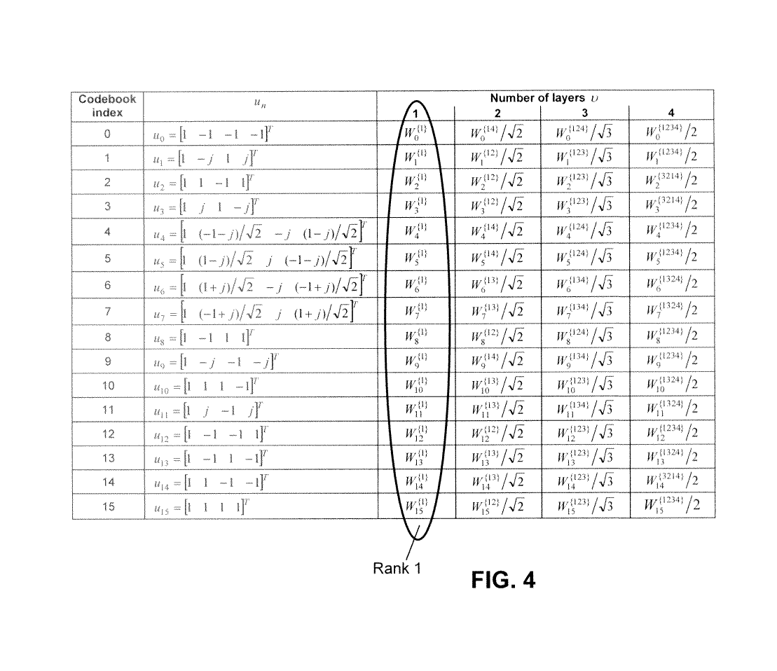

One example is best illustrated using the 4-Tx codebook for 2-Tx transmission as shown in FIG. 2. FIG. 2 illustrates that the eNB transmits on ports 15 and 16 (that is, these ports are energized), but does not transmit on ports 17 and 18 (that is, these ports are not energized). To be “not energized” means zero transmit power is applied to at least CSI-RS for the specific UE on the port. An energized port will have non-zero transmit power applied to at least CSI-RS for the specific UE on the port. In this context, “puncturing” refers to not energizing some of the CSI-RS ports used for a transmission. It is noted that ports 15-18 are used to carry CSI-RS for a 4-tx system; ports 15-22 are used to carry CSI-RS for an 8-tx system. Suppose the scheme illustrated in part by FIGS. 3 and 4 is implemented. The rank 1 codewords are indicated in FIGS. 3 and 4. FIG. 3 illustrates a 2-Tx codebook, while FIG. 4 illustrates a 4-Tx codebook. Also consider the following:

1. Suppose that a UE is configured in transmission mode 9 or in transmission mode 10, with a 4-Tx CSI-RS configuration (i.e., with CSI-RS ports 15-18).

2. On REs corresponding to CSI RS ports 15 and 16, the CSI-RS signals are transmitted; and on REs corresponding to CSI RS port 17 and 18, the CSI-RS signals are not transmitted. This is illustrated by FIG. 2, where ports 15 and 16 are indicated as being energized and ports 17 and 18 are indicated as being not energized.

3. The UE receiver model is then given by

$$y = {H}_{r \times 2} [ \begin{matrix}{s}_{15} \\ {s}_{16}\end{matrix} ] + n ,$$

where y is a received signal, H_{r×2} is the channel matrix, s₁₅ is a codeword for port 15, s₁₆ is a codeword for port 16, and n is a noise vector, and r the number of receive antennas on the UE. The UE uses the 4-Tx codebook to search for the best codeword. Ignoring the noise corresponding to ports 17 and 18 for the time being, then effectively only the first two rows of each 4-Tx codeword are used in the codeword search. It is noted that in an LTE network, muting CSI-RS on adjacent cells are typically used to boost the CSI-RS signal quality at the cell of interest. At the cell of interest, muting CSI-RS at adjacent cells lead to reduced inter-cell interference on ports 15-18. This can be performed, e.g., through network planning or a software program, or an engineer can configure the NZP CSI-RS and muting CSI-RS on different cells. It is also possible to configure muting CSI-RS in adjacent cells with the sole goal to reduce the inter-cell interference level on ports 17 and 18. With either approach, the net result is that a channel estimate for ports 17 and 18 should have very low power. As no signal is transmitted on ports 17 and 18, they are completely bogus or fictional from the network's point of view; and they do not need to be associated with any physical antennas or radio frequency chains at the base station.

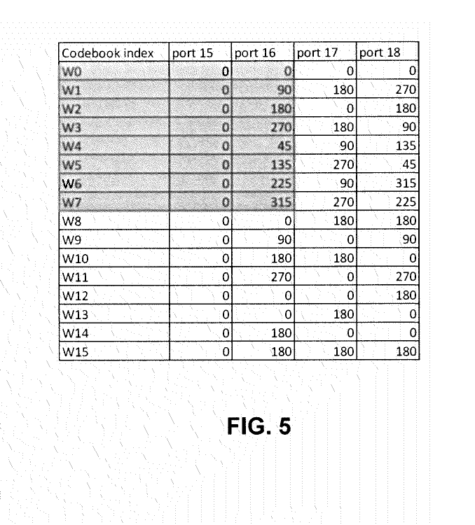

4. Recall in the rank-1, 2-Tx codebook, the phase difference between port 15 and port 16 is limited to 0°, 90°, and 180° and 270°. See FIG. 3 and more particularly FIG. 5, which illustrates port phase differences with respect to port 15 for rank-1 codewords in a current LTE 4-Tx codebook. By contrast, in the rank-1, 4-Tx codebook, the phase difference between port 15 and port 16 includes 45°, 135°, 225°, and 315° also (see FIGS. 4 and 5), besides the angles listed previously for the 2-Tx codebook. Consequently, a higher resolution codebook (e.g., twice as accurate) can be introduced and used without any specification change.

5. The eNodeB 140 may further assist the UE 110 by configuring a codebook subset restriction to allow for the UE to feed back codebook indices that correspond to unique combinations of transmission weights for ports 15 and 16. For instance, FIG. 5 shows that only codebook indices W0 . . . W7 are unique for ports 15 and 16, while indices W8 . . . W15 for these ports repeat some of the transmission weights that already exist on indices W0 . . . W7. Hence, the eNodeB 140 may configure the codebook subset restriction such that the UE may select the precoder only among indices W0 . . . W7 and not among indices W8 . . . WA since the latter indices are repetitive with W0 . . . W7.

6. When the PMI feedback from the UE 110 is received at the eNB 140, the eNB determines that the PMI feedback is chosen without anything transmitted on ports 17 and 18. Further, the truncated codeword (i.e., just the first two rows of the codeword indicated by the PMI) is used in the DMRS and data transmission to the UE. In FIG. 5, codeword subset restriction and precoder row selection are used to provide 8 (eight) phase resolutions from the 4-Tx codebook for a 2-Tx transmission.

Similar codebook subset restriction can also be defined for a rank 2, 2-Tx codebook.

### Section 2

### Using 8-Tx Codebook for 4-Tx Transmission with Puncturing

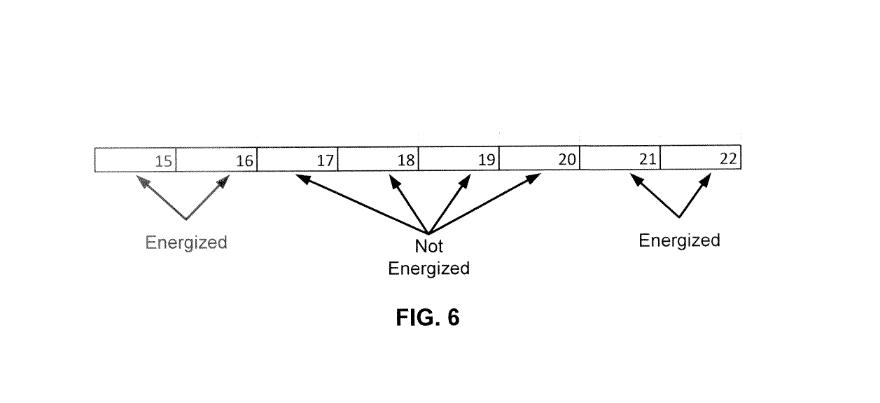

Similarly, to achieve a goal of enhancing the current 4-Tx codebook, a UE 1010 is configured with an 8-Tx CSI-RS configuration. In one example (see FIG. 6), only ports 15, 16, 21, and 22 are energized, and ports 17, 18, 19, and 20 are not energized. The UE will as a result effectively feedback the 4-Tx codeword, with the 8-Tx feedback mechanism. It should be noted all previous improvements currently in the 8-Tx codebook design (these improvements were all included in Rel. 10) such as dual codebook are kept, but no specification change is needed. It is further noted that in order to truncate an 8-Tx codeword corresponding to FIG. 6 to a 4-Tx codeword, one could use only the rows in the 8-Tx codeword corresponding to the energized ports (in this example, ports 15, 16, 21, and 22).

In LTE Rel-8, codeword subset restriction was introduced as a bitmap in RRC signaling. Each bit in the bitmap is for a codeword at each rank. The eNB can e.g. restrict the rank of CSI feedback by blocking all the codewords corresponding to a certain rank. The eNB can also specify the “preferred” codewords at a certain rank. In release 10, the codebook design for 2-Tx/4-Tx remains the same as in the previous release. As for 8-Tx, two matrices W₁ and W₂ are used to construct a precoding matrix. For example, at rank=1, there are 16 W₁ matrices and there are 16 W₂ matrices. Without codeword restriction, then there are 128 rank 1 codewords (even though there are 16×16=256 combinations of W₁ and W₂ there are 128 duplicate codewords). The codeword restriction in Release 10 for 8 Tx then takes the form of separately restricting the indices for W₁ and those for W.

To obtain a 4-Tx codebook from puncturing an 8-Tx codebook, the following exemplary techniques may be used (these may be seen as either alternatives or complementary solutions):
Perform permutation of the logical port index to physical antenna index mapping.
Use different puncturing patterns (such as [1 1 0 0 0 0 1 1], which creates the transmission shown in FIG. 6 for energizing ports 15, 16, 21, 22).
Apply a phase rotation on the energized ports, such as the following:

Apply

$$[ \begin{matrix}1 & & & \\ & {e}^{{jφ}_{1}} & & \\ & & {e}^{{jφ}_{2}} & \\ & & & {e}^{{jφ}_{3}}\end{matrix} ]$$

to ports 15, 16, 21, 22).

Note that these techniques may also be used in the repetition embodiments described herein, too. By just taking the first two operations, there are 1680 combinations, as shown by the following: 4!×C₈⁴=1680 (where C₈⁴ means “choose 4 out of 8”, i.e., the number of combinations of choosing four people out of 8 people (for example)). Among the combinations, there are 48 combinations which lead to a codebook of 32 rank-1 codewords, 96 combinations which lead to a codebook of 64 rank-1 codewords, and 1536 combinations which lead to a codebook of 128 rank-1 codewords. In total, 13,504 different rank-1 codewords can be generated among the combinations. In general, two indices come from {1,2,3,4}, the other two indices come from {5, 6, 7, 8} to ensure for higher ranks the codewords do not have too many duplicates. From this, we can see puncturing and permutation is a very powerful way to tailor the codebook for different deployment scenarios. In contrast to the approach of defining new codebooks for new deployment scenarios, which requires the eNB and UE have the same understanding and use of an identical codebook, and requires new implementation on the UE side once a new codebook is introduced; the disclosed approach hereby allows the network to customize the used codebook for data transmission through different puncturing and/or repetition patterns, logical port to physical antenna port mapping and phase rotations while at the same time the UE is agnostic or ignorant of the configuration/customization on the network side (eNB); and the UE implementation, especially that relevant to CSI feedback, is not required to be updated with each customization/configuration at the eNB side.

### Section 2

### Example One

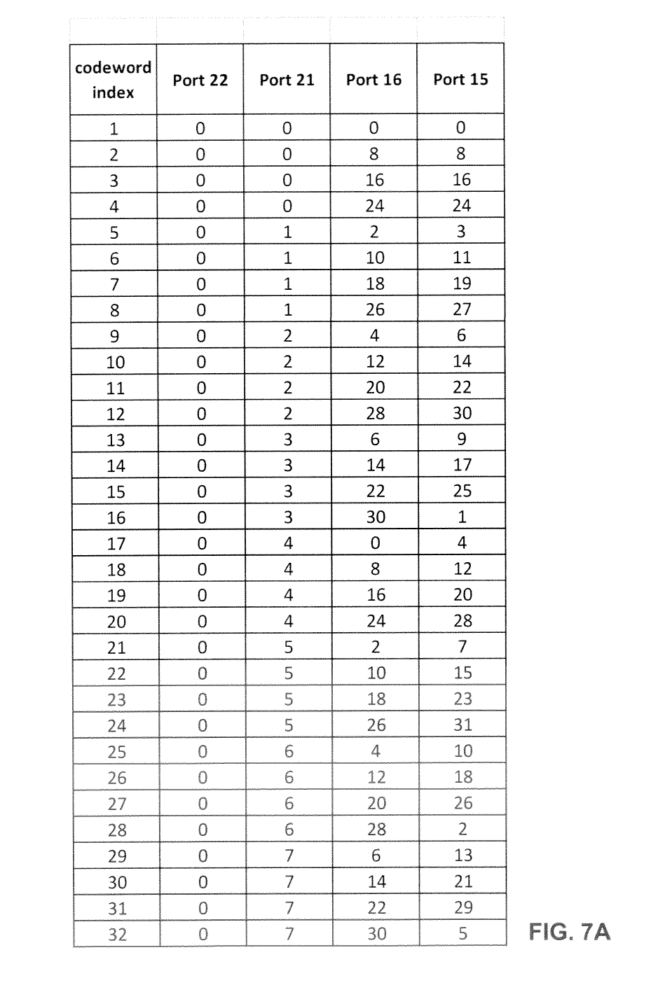

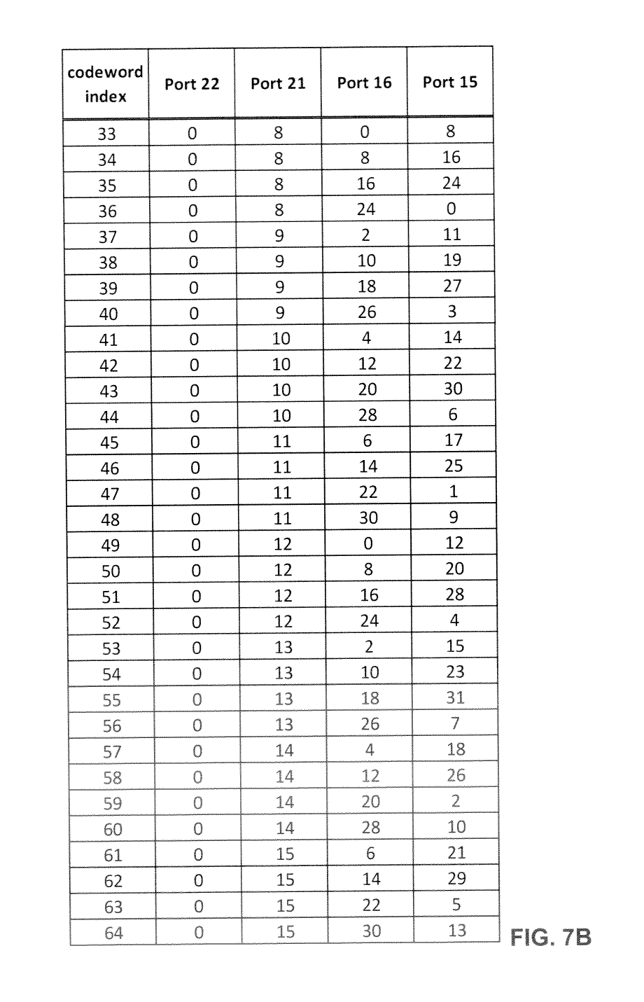

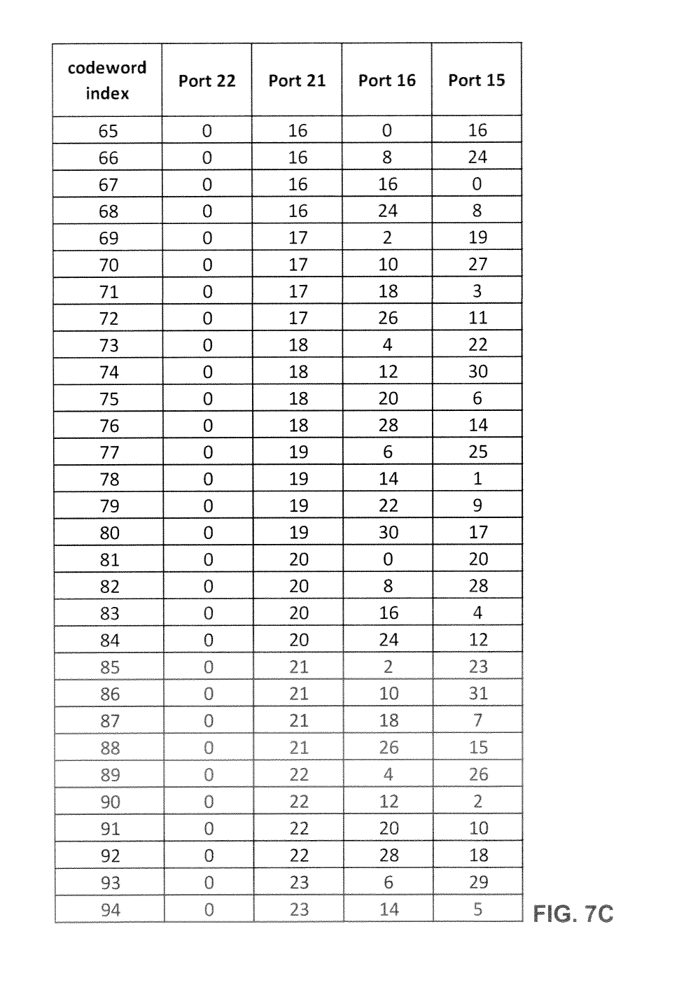

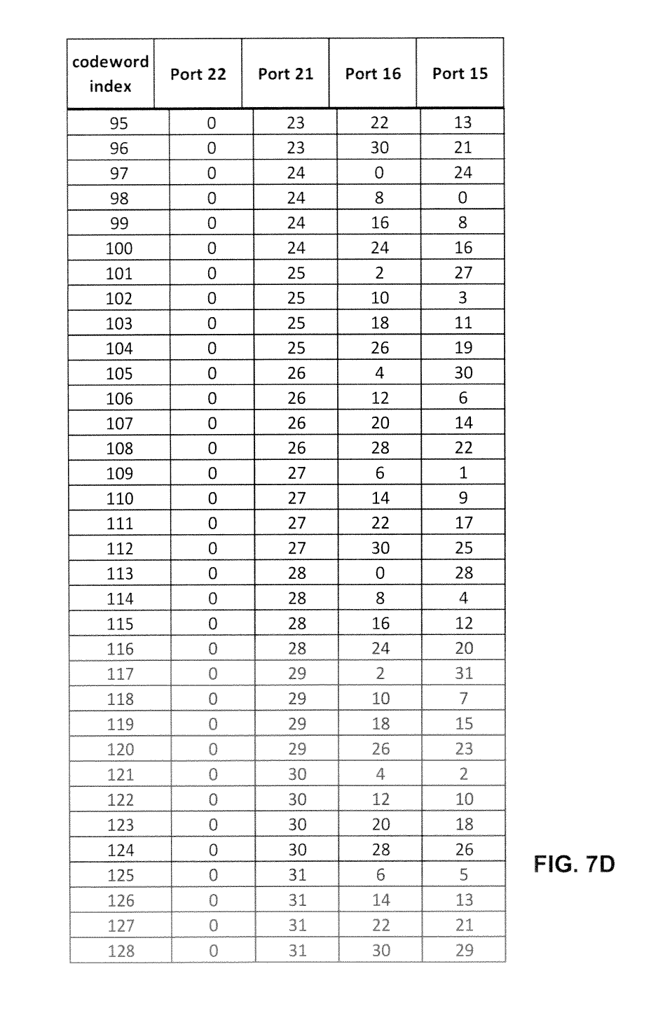

In one example, with the port mapping of [8 7 2 1] (note, “1” in the mapping corresponds to port 15 and “8” in the mapping corresponds to port 22, etc.), there is a restriction on i1 for rank=1 as [1010101010101010], and a restriction on i2 for rank=1 as [1000100010001000] to generate the codewords [1 e^{j2πm/32} e^{j4πm/32} e^{j6πm/32}]^{T},m=0, . . . , 31. Due to codeword restriction, in this case there are no duplicate codewords in the punctured codebook from 8-Tx. The 128 rank=1 codewords with restriction are given in FIGS. 7A-7D.

### Section 2

### Example Two

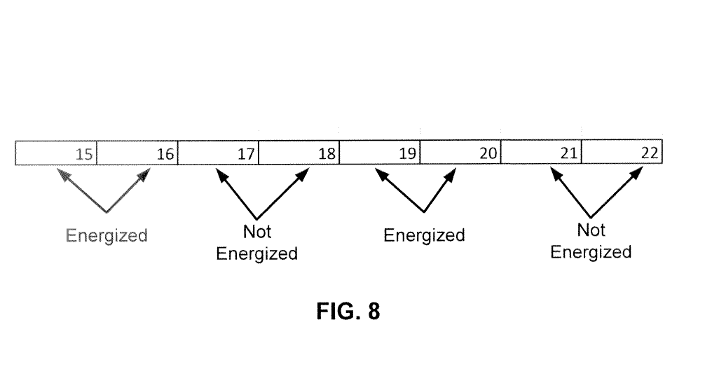

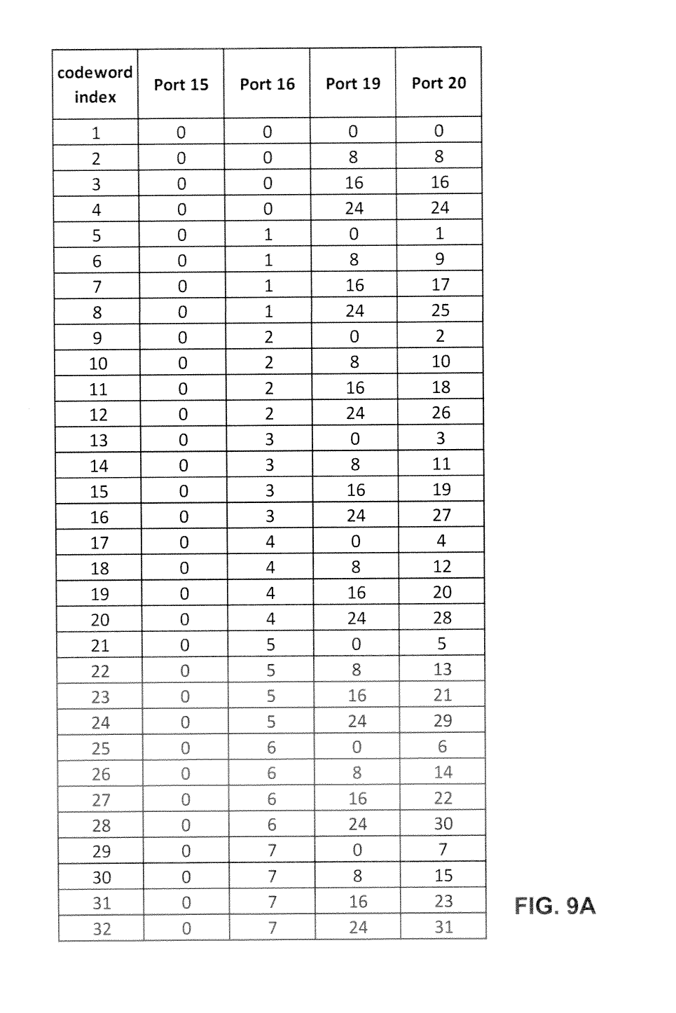

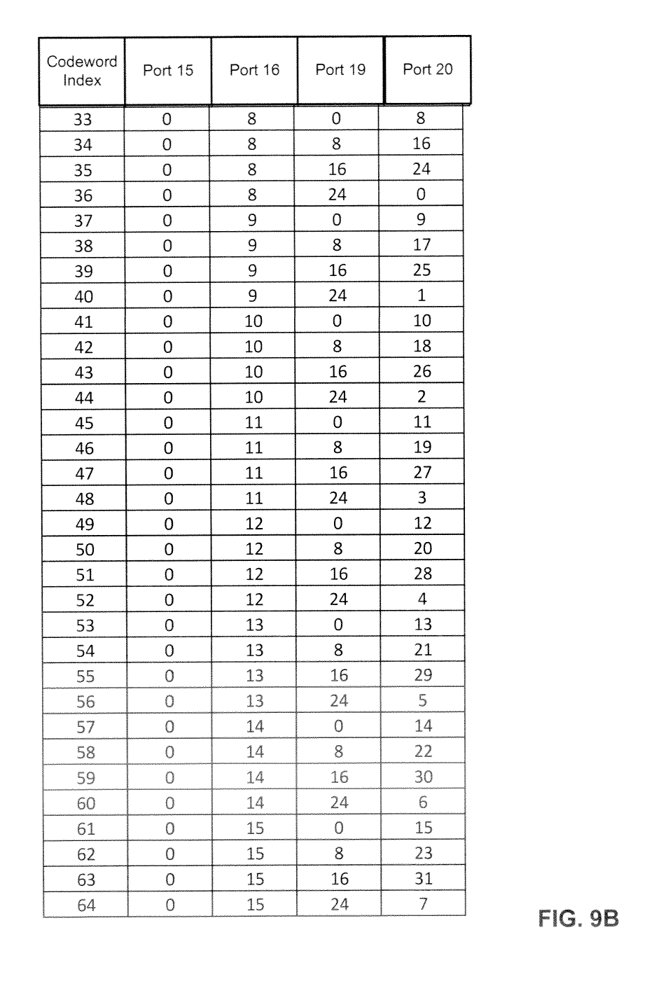

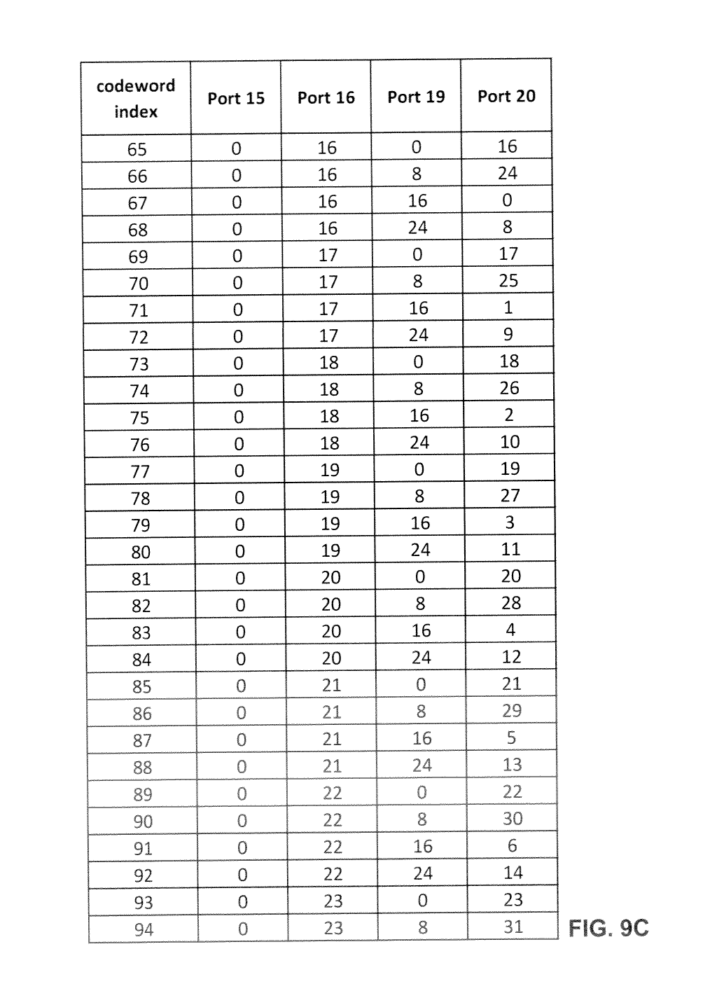

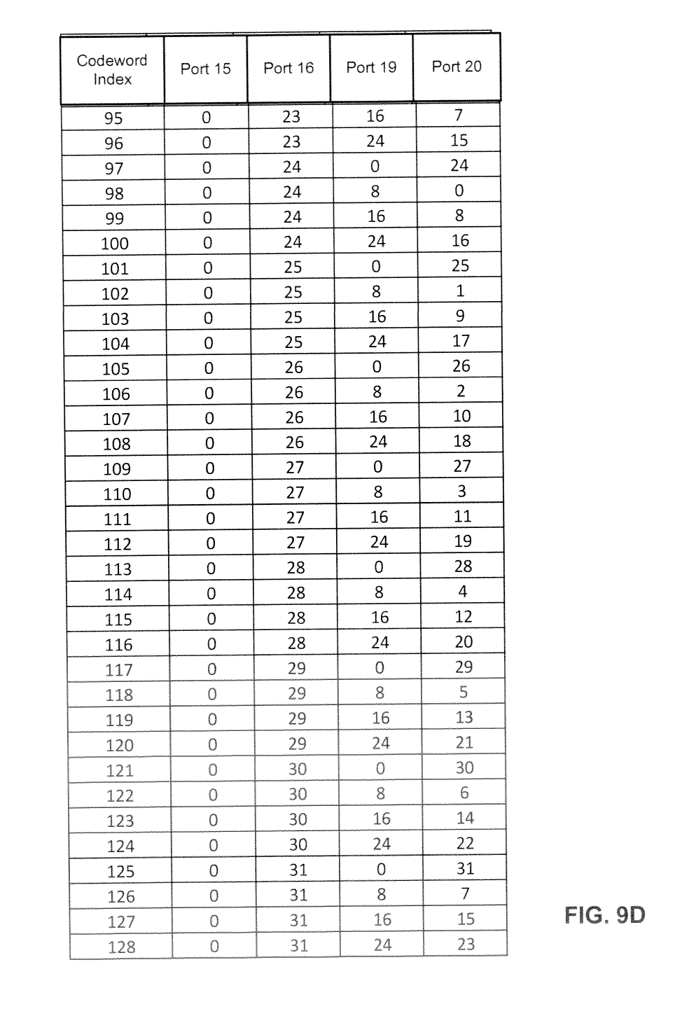

In another example, ports 15, 16, 19 and 20 are used as shown in FIG. 8. The 4-Tx codewords from puncturing the 8-Tx codewords are shown in FIGS. 9A-9D.

### Section 2

### Additional Comments

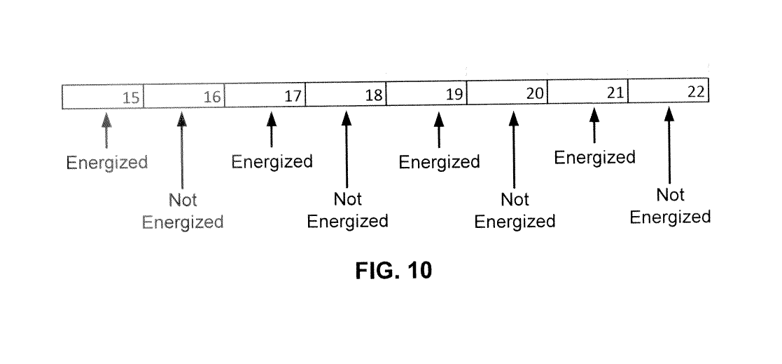

FIG. 10 illustrates yet another exemplary use of an 8-Tx codebook for 4-Tx transmission, where some of the 8 CSI-RS antenna ports are not energized. In this example, the odd ports are energized and the even ports are not energized.

The 4-Tx array can be treated as a subset of the 8-Tx array. Thus, row selections such as [1 2 7 8], [1 3 5 7], [1 4 5 8] all make sense, so half-wavelength spaced or 4-wavelength spaced antenna array layouts can be also supported. That is, the codebook does not have to support all possibilities, only one is enough. With proper permutation and rotation and codebook subset restriction, one can construct feedback for nearly any imaginable use case.

As the REs taken by the NZP CSI-RS in one cell are typically set as muted or zero power (that is, not energized) CSI-RS in adjacent cells, the energized ports in the NZP (that is, energized) CSI-RS get boosted SNR, while the non-energized ports (e.g., unused ports) in the NZP-CSI-RS see low inter-cell interference. That is, the non-energized ports are still nominally NZP CSI-RS. However, nothing is transmitted over them as previously noted. Consequently, a “bogus” channel measurement on the unused ports in the NZP CSI-RS will not create a problem in CSI feedback. Furthermore, in case some of the CSI-RS ports are left not energized, the respective transmit power may be used to boost other CSI-RS. To clarify, there are only 4 antennas on the eNB (though the eNB instructs the UE to perform measurement according to 8-tx CSI-RS configuration). Now, since 4 out of 8 CSI ports are actually not transmitted on the eNB, the power which would have been used to transmit data symbol or CSI-RS now can be borrowed to transmit signals at other 4 energized ports.

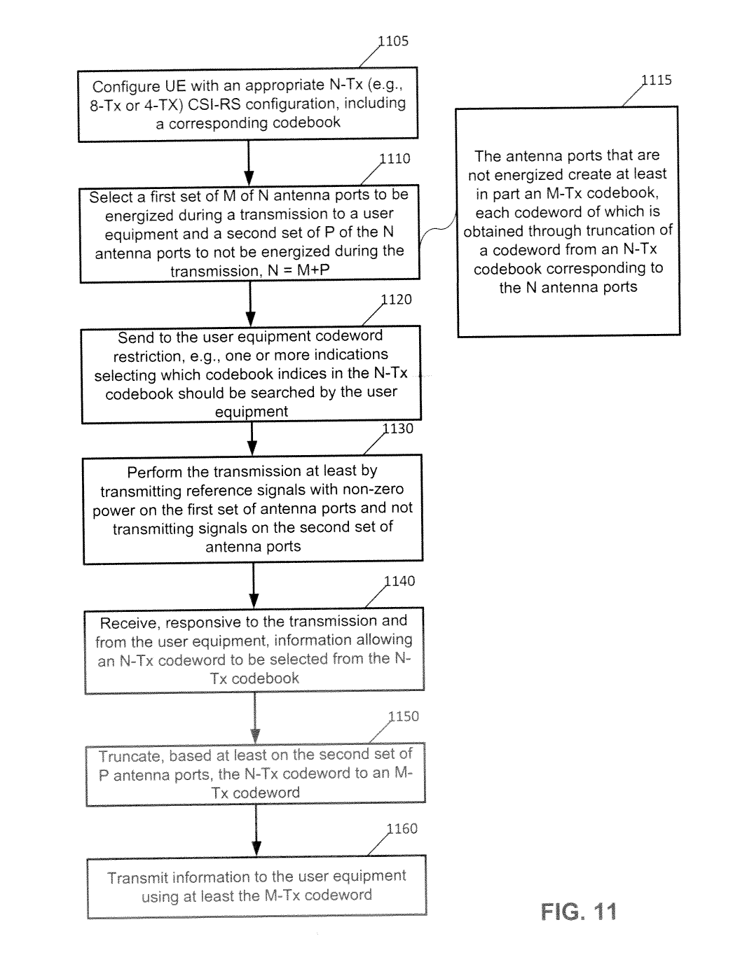

Turning to FIG. 11, a logic flow diagram is shown that illustrates the operation of an exemplary method, a result of execution of computer program instructions embodied on a computer readable memory, and/or functions performed by logic implemented in hardware, in accordance with an exemplary embodiment. FIG. 11 is performed by an eNB 140 or other network node. In this example, the blocks of FIG. 11 are assumed to be performed by eNB 140. The flow in FIG. 11 begins in block 1105, where a UE is configured with an appropriate N-Tx (e.g., 8-Tx or 4-TX) CSI-RS configuration, including a corresponding codebook. A typical scenario is that the eNB 140 configures the UE through dedicated RRC signaling, although this is an example.

In block 1110, the eNB 140 selects a first set of M of N antenna ports to be energized during a transmission to a user equipment and a second set of P of the N antenna ports to not be energized during the transmission, where N=M+P (each of M and P>0). Although the scenarios described herein include M=2, P=2, and N=4, or M=4, P=4, and N=8, other scenarios such as M=6, P=2, and N=8 are possible. As can be seen in block 1115, the antenna ports that are not energized create at least in part an M-Tx codebook, each codeword of which is obtained through truncation of a codeword from an N-Tx codebook corresponding to the N antenna ports. A point to make is the M-Tx codebook is a set with elements (i.e., codewords) {t1,t2, . . . , t8}, where t1, . . . , t8 are the M-Tx codewords, and the N-Tx codebook is a set with elements (i.e., codewords) {W0, . . . , W15}, where W0, . . . , W15 are the N-Tx codewords. Note that t1, . . . , t8 are 2 by 1 matrices, and W0, . . . , W15 are 4 by 1 matrices. So codewords in an M-Tx codebook may be created by truncating the codewords in the N-Tx codebook, and the truncation is effectively performed by not energizing the P ports. Put another way, the P antenna ports (to not be energized) effectively convert a 4-Tx codebook to a 2-Tx codebook or convert (at least in part) an 8-Tx codebook to a 4-Tx codebook. Further, the selection and feedback of a 2-Tx/4-Tx codeword is made in the disguise of selection of and feeding back a 4-Tx/8-Tx codeword.

Block 1120 is optional. In block 1120, the eNB 140 sends to the user equipment 110 codeword restriction, e.g., one or more indications selecting which codebook indices in the N-Tx codebook should be searched by the user equipment. For instance, as referred to above in reference to FIG. 5, block 1120 can involve sending indication(s) of codebook subset restriction such that the UE may select the precoder only among indices W0 . . . W7.

In block 1130, the eNB 140 performs the transmission at least by transmitting reference signals with non-zero power on the first set of antenna ports and not transmitting signals on the second set of antenna ports. In block 1140, the eNB 140 receives, responsive to the transmission and from the user equipment, information allowing an N-Tx codeword to be selected from the N-Tx codebook. In block 1150, the eNB 140 truncates, based at least on the second set of P antenna ports, the N-Tx codeword to an M-Tx codeword. In other words, the received codeword corresponds to a 4-Tx (or 8-Tx) codeword, but the eNB 140 will use only a 2-Tx (or 4-Tx, respectively) portion of that codeword. The resultant M-Tx codeword may be used for data transmission or control channel transmission such as in EPDCCH. The resulting precoding matrix (e.g., the codeword) is then used for DMRS and data (and possibly control signals) transmission towards the UE. This is illustrated by block 1160, in which the eNB 140 transmit information to the user equipment using at least the M-Tx codeword.

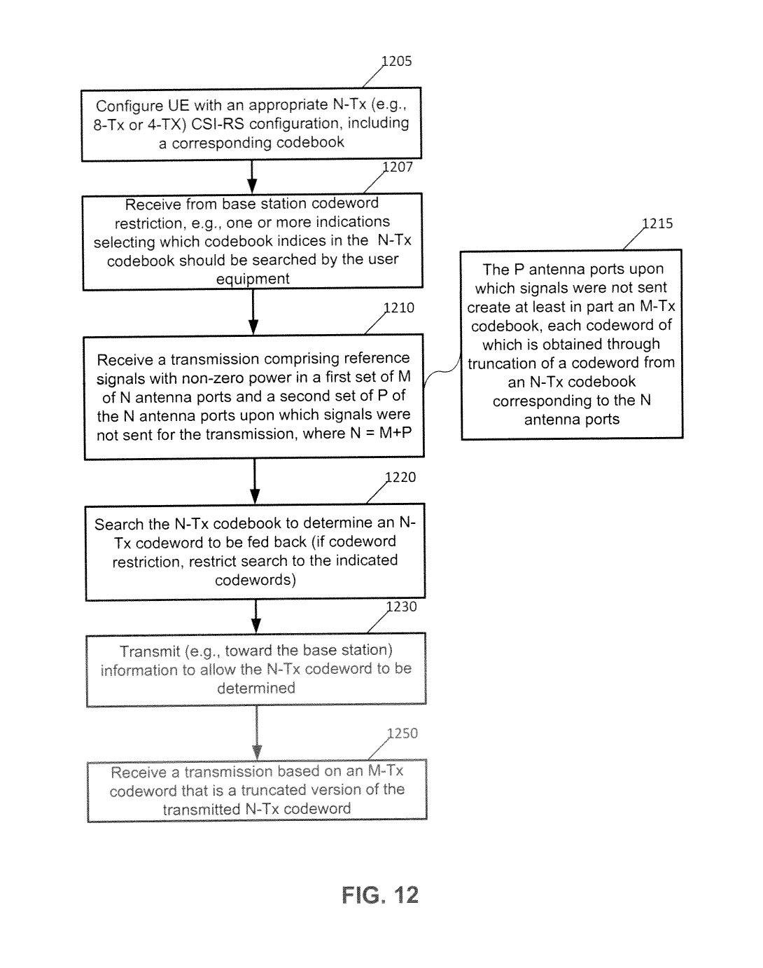

Referring to FIG. 12, FIG. 12 is a logic flow diagram that illustrates the operation of an exemplary method, a result of execution of computer program instructions embodied on a computer readable memory, and/or functions performed by logic implemented in hardware, in accordance with an exemplary embodiment. FIG. 12 is performed by a user equipment 110 and is performed by the user equipment in parallel with the operations performed in FIG. 11 by the eNB 140.

In block 1205, the UE is configured with an appropriate (e.g., 8-Tx or 4-TX) CSI-RS configuration, including a corresponding codebook. Block 1207 is optional and corresponds to block 1120 of FIG. 11. In block 1207, the user equipment 110 receives from the base station (e.g., eNB 140) codeword restriction, e.g., one or more indications selecting which codebook indices in the N-Tx codebook should be searched by the user equipment.

In block 1210, the user equipment 110 receives a transmission comprising reference signals with non-zero power in a first set of M of N antenna ports and a second set of P of the N antenna ports upon which signals were not sent for the transmission, where N=M+P (and each of M and P is greater than zero). As block 1215 illustrates, the P antenna ports upon which signals were not sent create at least in part an M-Tx codebook, each codeword of which is obtained through truncation of a codeword from an N-Tx codebook corresponding to the N antenna ports.

In block 1220, the user equipment 110 searches the N-Tx codebook to determine an N-Tx codeword to be fed back. If codeword restriction is being used, the UE will restrict its search to the codewords indicated in the restriction. In block 1230, the user equipment 110 transmits information to allow the N-Tx codeword to be determined, e.g., using CSI feedback such as PMI and RI. In block 1250, the user equipment 110 receives a transmission based on an M-Tx codeword that is a truncated version of the transmitted N-Tx codeword.

### Section 3

### Using an 8Tx/4Tx Codebook for 4Tx/2Tx, Respectively, Transmission Through Repetition

Instead of puncturing (i.e., not energizing) some of the 8 CSI-RS ports, another way to enable using 8-Tx codebook with 4-Tx transmission is to perform duplication. That is, the eNB 140 transmits the same signal from multiple CSI-RS ports. For instance, with a uniform linear array-type of 4-Tx antenna layout, one could transmit from each physical antenna the signal on resource elements corresponding to two different CSI-RS antenna ports. Due to the properties of the 8-Tx codebook, for the UE this corresponds to the case when there are 8 antenna ports, comprising an array of four cross-polarized antenna elements having full correlation between each cross-polarized antenna element. The eNodeB 140 may also configure the codebook subset restriction so that the phase offset between cross-polarized antennas is set to be always zero. As now the allowed codeword in the codebook is forced to have a repeated pattern, other codewords in the codebook which do not conform to this repeated pattern are excluded from codeword search at the UE side, e.g., through codeword restriction signaled by eNB to the UE.

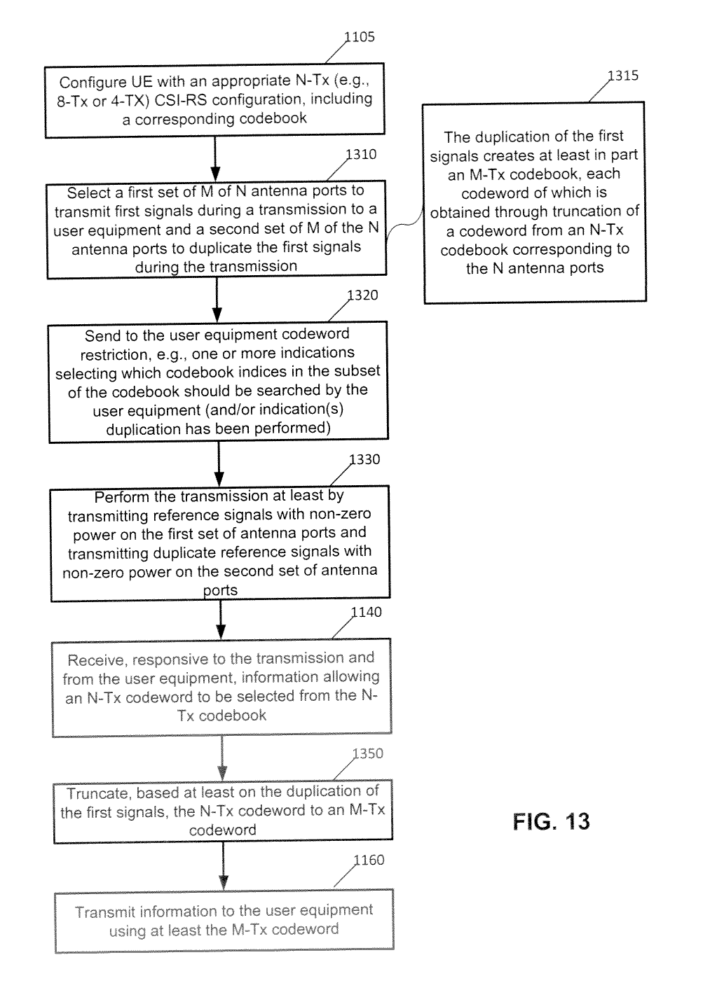

Turning to FIG. 13, a logic flow diagram is shown that illustrates the operation of an exemplary method, a result of execution of computer program instructions embodied on a computer readable memory, and/or functions performed by logic implemented in hardware, in accordance with an exemplary embodiment. FIG. 13 is performed by an eNB 140 or other network node and is similar to FIG. 11. Most of the blocks have been described in relation to FIG. 11. Block 1105 has already been described. In block 1310, the eNB 140 selects a first set of M of N antenna ports to transmit first signals during a transmission to a user equipment and a second set of M of the N antenna ports to duplicate the first signals during the transmission. As indicated by block 1315, the duplication of the first signals creates at least in part an M-Tx codebook, each codeword of which is obtained through truncation of a codeword from an N-Tx codebook corresponding to the N antenna ports. In the main examples herein, N=2M (e.g., N=8 and M=4). However, this is merely exemplary. For instance, one could have the following: N=2M′+P, P>0, M=M′+P, where M is for M-Tx codebook. If N=8, M=6, then P=4 and M′=2, this would provide one possible example. Another example might be N=4M′+P. P could be zero in these examples.

Block 1320 is optional. In block 1320, the eNB 140 sends to the user equipment codeword restriction, e.g., one or more indications selecting which codebook indices in the subset of the codebook should be searched by the user equipment. In addition or alternatively, the codeword restriction may also provide indication(s) duplication has been performed. The UE 110, using the indication(s) that duplication has been performed can therefore limit the portion of codewords to be searched (e.g., search 4-Tx code portions instead of search 8-Tx code portions of codewords). In block 1330, the eNB 140 performs the transmission at least by transmitting reference signals with non-zero power on the first set of antenna ports and transmitting duplicate reference signals with non-zero power on the second set of antenna ports. Blocks 1140 and 1160 have already been described above. In block 1350, the eNB 140 truncates, based at least on the duplication of the first signals (e.g., which were transmitted on the second set of antenna ports), the N-Tx codeword to an M-Tx codeword. In other words, the received codeword corresponds to a 4-Tx (or 8-Tx) codeword, but the eNB 140 will use only a 2-Tx (or 4-Tx, respectively) portion of that codeword.

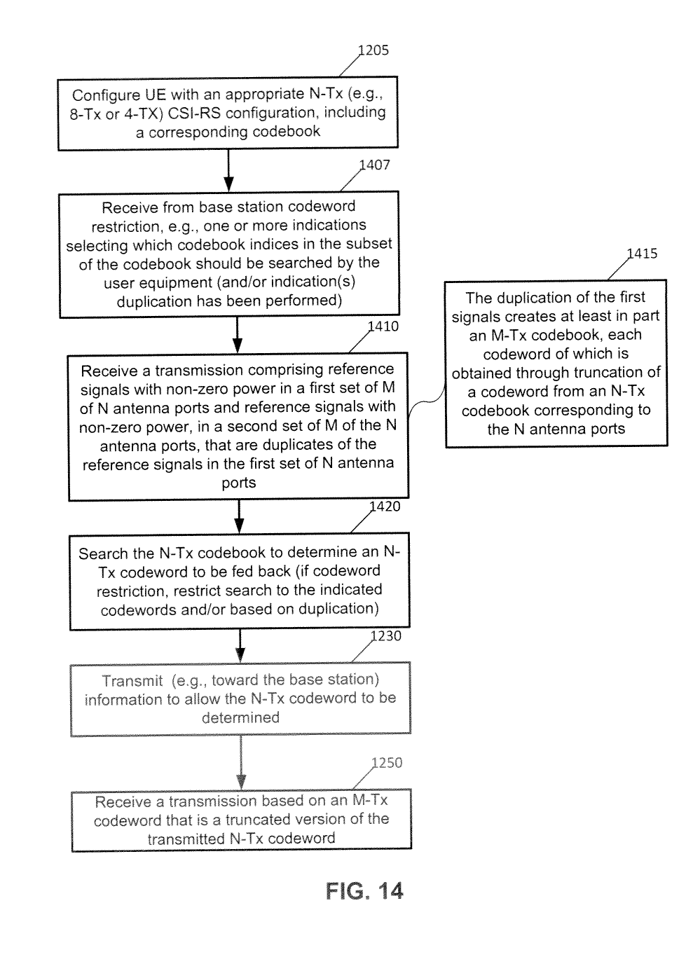

Referring to FIG. 14, this figure is a logic flow diagram that illustrates the operation of an exemplary method, a result of execution of computer program instructions embodied on a computer readable memory, and/or functions performed by logic implemented in hardware, in accordance with an exemplary embodiment. FIG. 14 is performed by a user equipment 110 and is performed by the user equipment in parallel with the operations performed in FIG. 13 by the eNB 140. FIG. 14 is also similar to FIG. 12 and most of the blocks have already been described in relation to FIG. 12. For instance, block 1205 of FIG. 14 has already been described above.

In block 1407, the UE 110 receives from base station codeword restriction, e.g., one or more indications selecting which codebook indices in the subset of the codebook should be searched by the user equipment (and/or indication(s) duplication has been performed). In block 1410, the user equipment 110 receive a transmission comprising reference signals with non-zero power in a first set of M of N antenna ports and reference signals with non-zero power, in a second set of M of the N antenna ports, that are duplicates of the reference signals in the first set of N antenna ports. As illustrated by block 1415, the duplication of the first signals creates at least in part an M-Tx codebook, each codeword of which is obtained through truncation of a codeword from an N-Tx codebook corresponding to the N antenna ports. In block 1420, the UE 110 searches the N-Tx codebook to determine an N-Tx codeword to be fed back. If there is codeword restriction, the UE can restrict search to the indicated codewords and/or to portions of codewords based on duplication. Blocks 1230 and 1250 have already been described above.

### Section 4

### Additional Comments

So far, disclosure has been made only of implementation specific examples to introduce a 4-Tx codebook. It is also possible to consider small specification change versions of this idea. For instance, the UE is signaled of the row selection of the codebook. Alternatively, the UE may be signaled which of the antenna ports are not energized. As there may be benefit to keep all the options open to deal with each possible deployment, the 4 bits for W1 and 4 Bits for W2 can be kept. Further study may reveal actually there is room for optimization to reduce number of bits for the matrices W₁/W₂, which leads to a larger specification change.

In summary, the following are one possible exemplary set of steps:

1. For an eNB 140 equipped with four (or two) antennas, a UE 110 in the transmission mode 9/10 is configured with 8-port (or 4-port) CSI-RS configuration.

2. At the eNB, four (or two) CSI-RS ports among the configured eight (or four) ports are not energized; the rest of them (four or two ports) are energized, which constitutes row selection of the precoder matrix.

a. Alternatively, the same signal may be transmitted from multiple (two) CSI-RS antenna ports.

3. A UE searches the best PMI according to the 8-Tx (or 4-Tx) codebook. Codeword subset restriction can be applied to mitigate the search complexity and to avoid estimating redundant PMIs. The UE sends an indication of the best PMI to the eNB.

4. From the PMI feedback, the eNB finds the corresponding 8-Tx (or 4-Tx) codeword, but truncates (i.e., ignores) the rows, columns, or terms corresponding to the non-energized CSI-RS ports. That is, the eNB removes, e.g., the rows as the rows bear no relevance in the choice of PMI on the UE side in the first place; and the eNB knows very well the rows corresponding to the non-energized CSI-RS ports are not useful (e.g., bogus). Some rows are removed, so the remaining rows are used as the precoding matrix for data transmission or control channel transmission such as in EPDCCH. The resulting precoding matrix is then used for DMRS and data (and possibly control signals) transmission towards the UE.

Steps 1-4 can be conducted in an implementation specific way, no specification change is needed except some perhaps aspects on UE capability issues.

5. The removal of rows of the precoding matrix can be also made explicitly by mandating removal in specification(s). In this case, signaling of the removal of rows in the precoding matrices from eNB is sent to a UE so it is explicitly instructed to ignore those rows in the codewords in RI (Rank Indicator)/PMI/CQI selection. It is possible at each rank, different rows are removed; and accompanying codeword restriction can be also rank dependent.

Considering the idea of puncturing and repetition, a more general formulation of the technique is as follows:

The eNB applies a precoder P on 8Tx CSI-RS ports:

$$P = [ \begin{matrix}{p}_{11} & {P}_{12} & {P}_{13} & {P}_{14} \\ {p}_{21} & {P}_{22} & {P}_{23} & {P}_{24} \\ {p}_{31} & {P}_{32} & {P}_{33} & {P}_{34} \\ {p}_{41} & {P}_{42} & {P}_{43} & {P}_{44} \\ {p}_{51} & {P}_{52} & {P}_{53} & {P}_{54} \\ {p}_{61} & {P}_{62} & {P}_{63} & {P}_{64} \\ {p}_{71} & {P}_{72} & {P}_{73} & {P}_{74} \\ {p}_{81} & {P}_{82} & {P}_{83} & {P}_{84}\end{matrix} ]$$

For the puncturing scheme

$$P = Φ {\prod }_{8 \times 8} [ \begin{matrix}{I}_{4 \times 4} \\ {0}_{4 \times 4}\end{matrix} ]$$

For the repetition scheme

$$P = Φ {\prod }_{8 \times 8} [ \begin{matrix}{I}_{4 \times 4} \\ {I}_{4 \times 4}\end{matrix} ]$$

where Π is a permutation matrix, Φ is a diagonal matrix {e^{jφ}^{ᵢ}}, and φᵢ is phase rotation the eNB applies on a CSI-RS port. In both cases, the rank of P is 4. In general, a rank 4 8×4 matrix which does not necessarily have either of the above structures can be applied by an eNB.

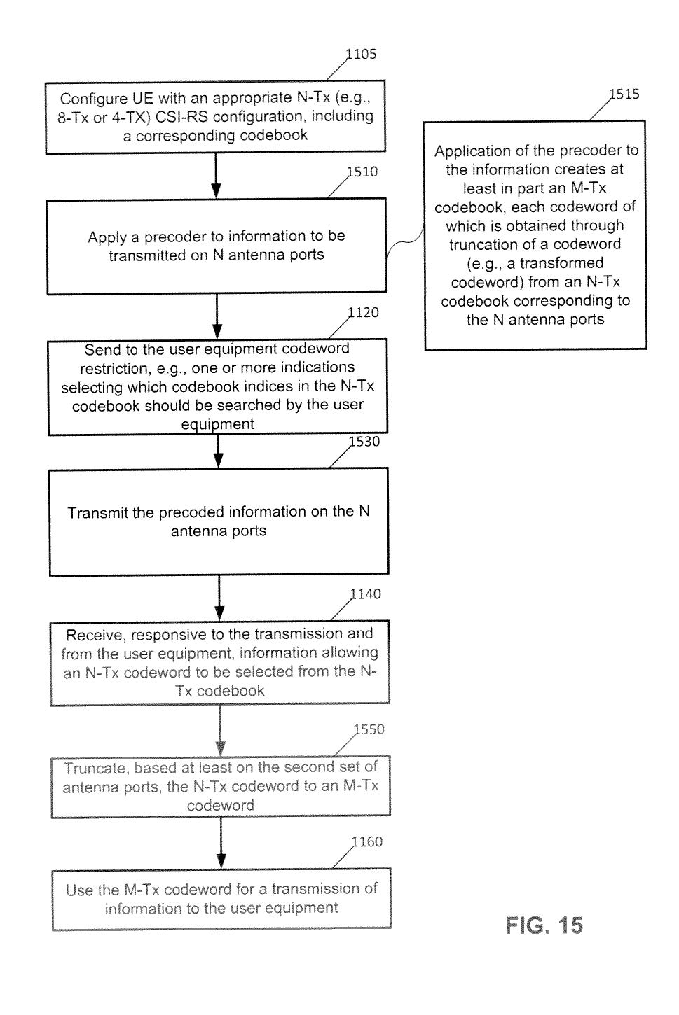

Turning to FIG. 15, a logic flow diagram is shown that illustrates the operation of an exemplary method, a result of execution of computer program instructions embodied on a computer readable memory, and/or functions performed by logic implemented in hardware, in accordance with an exemplary embodiment. FIG. 15 is performed by an eNB 140 or other network node. In this example, the blocks of FIG. 15 are assumed to be performed by eNB 140. FIG. 15 involves the generalization of FIGS. 11 and 13, as choice of the precoder can dictate whether certain of the operations of FIG. 11 or FIG. 13 are performed. Note that similar generalizations may be made to FIGS. 12 and 14. Most of the blocks in FIG. 15 have been described above in reference to FIG. 11, so mainly the differences are described here.

The flow in FIG. 15 begins in block 1105, described above. In block 1510, the eNB 140 applies a precoder (P) to information to be transmitted on N antenna ports. As illustrated by block 1515, application of the precoder to the information creates at least in part an M-Tx codebook, each codeword of which is obtained through truncation of a codeword (e.g., a transformed codeword) from an N-Tx codebook corresponding to the N antenna ports. The term “transformed” is used in the mathematical sense. In other words, if B=A P, where A is a vector, B is a vector, P is a matrix, then one may say “A is transformed by P to obtain B”. Block 1120 has been described above. Note that block 1320 may be performed, e.g., indication(s) duplication has been performed may be sent by the eNB 140. In block 1530, the eNB 140 transmits the precoded information on the N antenna ports. Blocks 1140 and 1160 have been described above. In block 1550, the eNB 140 truncates, based at least on the second set of antenna ports, the N-Tx codeword to an M-Tx codeword. For instance, either of blocks 1150 or 1350 may be used, depending on whether puncturing or repetition, respectively, is being used. As stated above, the received codeword corresponds to a 4-Tx (or 8-Tx) codeword, but the eNB 140 will use only a 2-Tx (or 4-Tx, respectively) portion of that codeword.

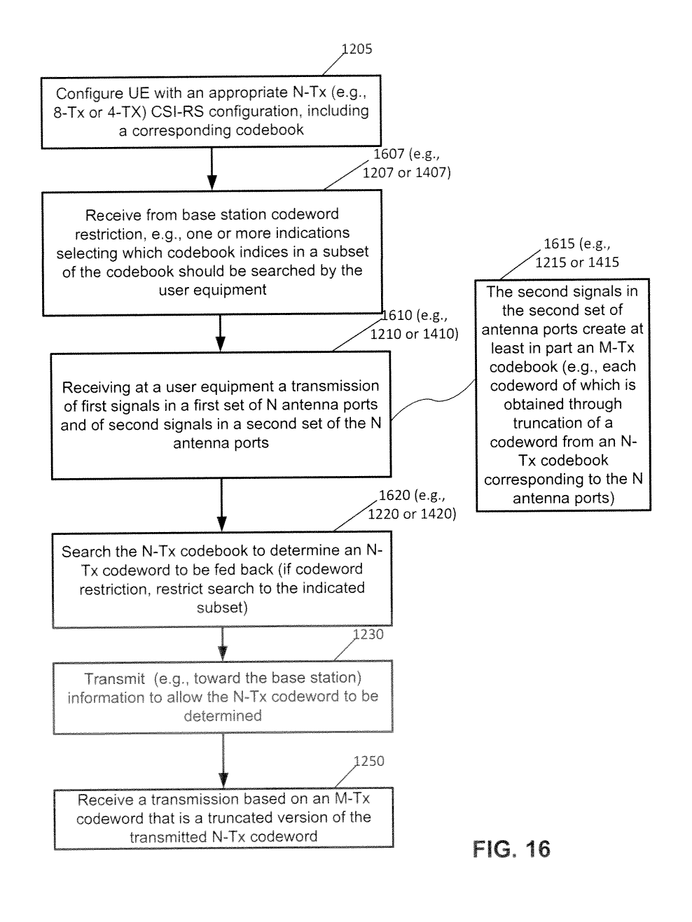

Referring now to FIG. 16, a logic flow diagram is shown that illustrates the operation of an exemplary method, a result of execution of computer program instructions embodied on a computer readable memory, and/or functions performed by logic implemented in hardware, in accordance with an exemplary embodiment. FIG. 16 is performed by UE 110. FIG. 16 involves the generalization of FIGS. 12 and 14, as choice of the precoder can dictate whether certain of the operations of FIG. 12 or FIG. 14 are performed. Most of the blocks in FIG. 16 have been described above in reference to FIG. 12 or 14, so mainly the differences are described here.

Block 1205 has been described above. In block 1607, the UE 110 optionally receives from a base station codeword restriction, e.g., one or more indications selecting which codebook indices in a subset of the codebook should be searched by the user equipment. This block may be block 1207 or 1407 or similar. In block 1610, the UE 110 receives at a user equipment a transmission of first signals in a first set of N antenna ports and of second signals in a second set of the N antenna ports. Block 1610 may be block 1210 or 1410 or similar. In block 1615, the second signals in the second set of antenna ports create at least in part an M-Tx codebook (e.g., each codeword of which is obtained through truncation of a codeword from an N-Tx codebook corresponding to the N antenna ports). Block 1615 may be block 1215, 1415, or similar. In block 1620, the UE 110 searches the N-Tx codebook to determine an N-Tx codeword to be fed back (if codeword restriction, restrict search to the indicated subset). Block 1620 may be block 1220 or 1420 or similar. Blocks 1230 and 1250 have been described previously.

The following are additional examples.

### Example 1

A method includes: selecting a first set of M of N antenna ports to be energized during a transmission to a user equipment and a second set of P of the N antenna ports to not be energized during the transmission, N=M+P, wherein the antenna ports that are not energized create at least in part an M-Tx codebook, each codeword of which is obtained through truncation of a codeword from an N-Tx codebook corresponding to the N antenna ports; performing the transmission at least by transmitting reference signals with non-zero power on the first set of antenna ports and not transmitting signals on the second set of antenna ports; receiving, responsive to the transmission and from the user equipment, information allowing an N-Tx codeword to be selected from the N-Tx codebook; truncating, based at least on the second set of P antenna ports, the N-Tx codeword to an M-Tx codeword; and using the M-Tx codeword for a transmission of information to the user equipment.

### Example 2

The method of example 1, wherein M is two and a number of the first set of antenna ports to be energized is two, P is two and a number of the second antenna ports to not be energized is two, and N is four.

### Example 3

The method of any one of examples 1 or 2, wherein the N-Tx codeword is a 4-Tx codeword, the M-Tx codeword is a 2-Tx codeword, and wherein truncating the 4-Tx codeword comprises truncating the 4-Tx codeword by using only a first two rows of the N-Tx codeword as the 2-Tx codeword.

### Example 4

The method of example 1, wherein truncating the N-Tx codeword comprises truncating the N-Tx codeword by using just a first M rows of the N-Tx codeword as the M-Tx codeword.

### Example 5

The method of example 1, wherein M is four and a number of the first set of antenna ports to be energized is four, P is four and a number of the second set of antenna ports to not be energized is four, and N is eight.

### Example 6

The method of example 5, further comprising obtaining a 4-Tx codebook from puncturing an 8-Tx codebook, wherein puncturing means some antenna ports are not energized, at least by using one or more of the following techniques: performing permutation of a logical port index to physical antenna index mapping; using different puncturing patterns for energizing or not energizing selected ones of the antenna ports; applying a phase rotation on the energized antenna ports.

### Example 7

The method of example 1, wherein M and P are not equal.

### Example 8

The method of any one of examples 2 to 8, further comprising, prior to transmitting, sending one or more indications selecting which codebook indices in the N-Tx codebook should be searched by the user equipment, wherein the selected codebook indices are less than all of the indices in the N-Tx codebook.

### Example 9

The method of example 9, wherein subset restriction caused by the selected codebook indices being less than all of the indices in the N-Tx codebook allows for the user equipment to feed back codebook indices that correspond only to unique combinations of transmission weights for particular antenna ports and transmission weights that are repetitive with the unique combinations are not included in the subset restriction.

### Example 10

The method of any one of examples 1 to 9, wherein using the M-Tx codeword for a transmission of information to the user equipment further comprises using the M-Tx codeword for a transmission of demodulation reference signals, data, or both demodulation reference signals and data to the user equipment.

### Example 11

A method, comprising: receiving at a user equipment a transmission comprising reference signals with non-zero power in a first set of M of N antenna ports and a second set of P of the N antenna ports upon which signals were not sent for the transmission, N=M+P, wherein the P antenna ports upon which signals were not sent create at least in part an M-Tx codebook, each codeword of which is obtained through truncation of a codeword from an N-Tx codebook corresponding to the N antenna ports; searching by the user equipment the N-Tx codebook to determine an N-Tx codeword to be fed back; and transmitting by the user equipment information to allow the N-Tx codeword to be determined.

### Example 12

The method of example 11, wherein M is two and a number of the first set of antenna ports with non-zero power is two, P is two and a number of the second antenna ports upon which signals were not sent is two, and N is four.

### Example 13

The method of example 11, wherein M is four and a number of the first set of antenna ports with non-zero power is four, P is four and a number of the second antenna ports upon which signals were not sent is four, and N is eight.

### Example 14

The method of example 11, wherein M and P are not equal.

### Example 15

The method of any one of examples 11 to 14, wherein: the method further comprises, prior to receiving, receiving one or more indications selecting which codebook indices in the N-Tx codebook should be searched by the user equipment, wherein the selected codebook indices are less than all of the indices in the N-Tx codebook; and searching further comprises searching only the selected codebook indices in the N-Tx codebook to determine an N-Tx codeword to be fed back.

### Example 16

The method of any one of examples 11 to 15, further comprising after transmitting receiving at the user equipment a transmission based on an M-Tx codeword that is a truncated version of the transmitted N-Tx codeword

### Example 17

The method of example 16, wherein receiving a transmission based on an M-Tx codeword further comprises receiving a transmission of demodulation reference signals, data, or both demodulation reference signals and data.

### Example 18

A method, comprising: selecting a first set of M of N antenna ports to transmit first signals during a transmission to a user equipment and a second set of M of the N antenna ports to duplicate the first signals during the transmission, wherein duplication of the first signals creates at least in part an M-Tx codebook, each codeword of which is obtained through truncation of a codeword from an N-Tx codebook corresponding to the N antenna ports; performing the transmission at least by transmitting reference signals with non-zero power on the first set of antenna ports and transmitting duplicate reference signals with non-zero power on the second set of antenna ports; and receiving, responsive to the transmission and from the user equipment, information allowing an N-Tx codeword to be selected from the N-Tx codebook; truncating, based at least on the duplication of the first signals, the N-Tx codeword to an M-Tx codeword; and using the M-Tx codeword for a transmission of information to the user equipment.

### Example 19

The method of example 18, wherein M is two, a number of the first set of antenna ports to transmit the first signals is two, a number of the second antenna ports to duplicate the first signals is two, and N is four.

### Example 20

The method of any one of examples 18 or 19, wherein the N-Tx codeword is a 4-Tx codeword, the M-Tx codeword is a 2-Tx codeword, and wherein truncating the 4-Tx codeword comprises truncating the 4-Tx codeword by using only a first two rows of the N-Tx codeword as the 2-Tx codeword.

### Example 21

The method of example 18, wherein truncating the N-Tx codeword comprises truncating the N-Tx codeword by using just a first M rows of the N-Tx codeword as the M-Tx codeword.

### Example 22

The method of example 18, wherein M is four, a number of the first set of antenna ports to transmit the first signals is four, a number of the second antenna ports to duplicate the first signals is four, and N is eight.

### Example 23

The method of example 18, wherein 2M+P=N, and P is an integer greater than zero.

### Example 24

The method of any one of examples 18 to 23, further comprising, prior to transmitting, sending one or more indications selecting which codebook indices in the N-Tx codebook should be searched by the user equipment, wherein the selected codebook indices are less than all of the indices in the N-Tx codebook.

### Example 25

The method of example 24, wherein subset restriction caused by the selected codebook indices being less than all of the indices in the N-Tx codebook allows for the user equipment to feed back codebook indices that correspond only to unique combinations of transmission weights for particular antenna ports and transmission weights that are repetitive with the unique combinations are not included in the subset restriction.

### Example 26

The method of any one of examples 18 to 25, wherein using the M-Tx codeword for a transmission of information to the user equipment further comprises using the M-Tx codeword for a transmission of demodulation reference signals, data, or both demodulation reference signals and data to the user equipment.

### Example 27

A method, comprising: receiving at a user equipment a transmission comprising reference signals with non-zero power in a first set M of N antenna ports and reference signals with non-zero power, in a second set M of the N antenna ports, that are duplicates of the reference signals in the first set of N antenna ports, wherein the user equipment is configured with an N-Tx codebook corresponding to the N antenna ports and duplication of the first signals creates at least in part an M-Tx codebook; searching the N-Tx codebook to determine an N-Tx codeword to be fed back; and transmitting the determined codeword from the user equipment.

### Example 28

The method of example 27, wherein searching comprises searching by the user equipment a subset that is less than all of the N-Tx codebook to determine a codeword to be fed back, wherein the subset of the codebook corresponds to the first set of antenna ports and not to the second set of antenna ports.

### Example 29

The method of example 28, wherein M is two, a number of the first set of antenna ports with non-zero power is two, a number of the second antenna ports upon which signals were not sent is two, and N is four.

### Example 30

The method of example 28, wherein M is four, a number of the first set of antenna ports with non-zero power is four, a number of the second antenna ports upon which signals were not sent is four, and N is eight.

### Example 31

The method of example 28, wherein 2M+P=N, and P is an integer greater than zero.

### Example 32

The method of any one of examples 28 to 31, wherein: the method further comprises, prior to receiving, receiving one or more indications selecting which codebook indices in the N-Tx codebook should be searched by the user equipment, wherein the selected codebook indices are less than all of the indices in the N-Tx codebook; and searching further comprises searching only the selected codebook indices in the N-Tx codebook to determine an N-Tx codeword to be fed back.

### Example 33

The method of any one of examples 27 to 32, further comprising after transmitting receiving at the user equipment a transmission based on an M-Tx codeword that is a truncated version of the transmitted N-Tx codeword.

### Example 34

The method of example 33, wherein receiving a transmission based on an M-Tx codeword further comprises receiving a transmission of demodulation reference signals, data, or both demodulation reference signals and data.

### Example 35

A computer program comprising program code for executing the method according to any of examples 1 to 34

### Example 36

The computer program according to example 36, wherein the computer program is a computer program product comprising a computer-readable medium bearing computer program code embodied therein for use with a computer.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

3GPP third generation partnership project

CQI channel quality indicator

CSI channel state information

CSI-RS channel state information-reference signal

DL downlink

DRMS demodulation reference signal

eNB or eNodeB base station, evolved Node B

EPDCCH enhanced physical downlink control channel

GW gateway

LTE long term evolution

LTE-A long term evolution-advanced

MIMO multiple in, multiple out

MME mobility management entity

NCE network control entity

NZP non-zero power

PDSCH physical downlink shared channel

PMI precoding matrix indicator

Rel release

RE resource element

RI Rank Indicator

RS reference signal

RRC radio resource control

SGW serving gateway

SNR signal-to-noise ratio

TS technical specification

Tx or tx transmission or transmitter

UE user equipment

ULA uniform linear array

ZP zero power

What is claimed is:

1. A method, comprising:
applying a precoder to information to be transmitted on N antenna ports, wherein application of the precoder to the information creates at least in part an M-Tx codebook, each codeword of which is obtained through truncation of a codeword from an N-Tx codebook corresponding to the N antenna ports;
transmitting the precoded information on the N antenna ports;
receiving, responsive to the transmission and from the user equipment, information allowing an N-Tx codeword to be selected from the N-Tx codebook;
truncating, based at least on the precoder, the N-Tx codeword to an M-Tx codeword; and
using the M-Tx codeword for a transmission of information to the user equipment.

2. The method of claim 1, wherein:
the information comprise reference signals;
applying a precoder selects a first set of M of the N antenna ports to be energized during a transmission to a user equipment and a second set of P of the N antenna ports to not be energized during the transmission, N=M+P, wherein the antenna ports that are not energized create at least in part an M-Tx codebook, each codeword of which is obtained through truncation of a codeword from an N-Tx codebook corresponding to the N antenna ports;
transmitting further comprises transmitting reference signals with non-zero power on the first set of antenna ports and not transmitting signals on the second set of antenna ports;
receiving further comprises receiving, responsive to the transmission and from the user equipment, information allowing an N-Tx codeword to be selected from the N-Tx codebook; and
truncating further comprises truncating, based at least on the second set of P antenna ports, the N-Tx codeword to an M-Tx codeword.

3. The method of claim 2, wherein one of the following is true:
M is two and a number of the first set of antenna ports to be energized is two, P is two and a number of the second antenna ports to not be energized is two, and N is four; or
M is four and a number of the first set of antenna ports to be energized is four, P is four and a number of the second set of antenna ports to not be energized is four, and N is eight.

4. The method of claim 1, wherein:
the information comprise reference signals;
applying a precoder selects a first set of M of N antenna ports to transmit first reference signals during a transmission to a user equipment and a second set of M of the N antenna ports to duplicate the first reference signals during the transmission, wherein duplication of the first reference signals creates at least in part the M-Tx codebook;
transmitting further comprises transmitting the first reference signals with non-zero power on the first set of antenna ports and transmitting duplicate reference signals with non-zero power on the second set of antenna ports; and
receiving further comprises receiving, responsive to the transmission and from the user equipment, information allowing an N-Tx codeword to be selected from the N-Tx codebook; and
truncating further comprises truncating, based at least on the duplication of the first reference signals, the N-Tx codeword to an M-Tx codeword.

5. The method of claim 4, wherein one of the following is true:
M is two, a number of the first set of antenna ports to transmit the first signals is two, a number of the second antenna ports to duplicate the first signals is two, and N is four; or
M is four, a number of the first set of antenna ports to transmit the first signals is four, a number of the second antenna ports to duplicate the first signals is four, and N is eight.

6. The method of claim 1, further comprising obtaining a 4-Tx codebook from an 8-Tx codebook, at least by using one or more of the following techniques:
performing permutation of a logical port index to physical antenna index mapping;
using different puncturing patterns for energizing or not energizing selected ones of the antenna ports;
applying a phase rotation on the energized antenna ports.

7. The method of claim 1, further comprising, prior to transmitting, sending one or more indications selecting which codebook indices in the N-Tx codebook should be searched by the user equipment, wherein the selected codebook indices are less than all of the indices in the N-Tx codebook.

8. A method, comprising:
receiving at a user equipment a transmission of first signals in a first set of N antenna ports and of second signals in a second set of the N antenna ports, wherein the second signals in the second set of antenna ports create at least in part an M-Tx codebook;
searching by the user equipment the N-Tx codebook to determine an N-Tx codeword to be fed back; and
transmitting by the user equipment information to allow the N-Tx codeword to be determined.

9. The method of claim 8, wherein:
the first signals are reference signals; and
receiving comprises receiving reference signals with non-zero power in the first set of M of the N antenna ports and receiving the second signals in the second set of P of the N antenna ports upon which signals were not sent for the transmission, N=M+P, wherein the P antenna ports upon which signals were not sent create at least in part the M-Tx codebook.

10. The method of claim 9, wherein one of the following is true:
M is two and a number of the first set of antenna ports with non-zero power is two, P is two and a number of the second antenna ports upon which signals were not sent is two, and N is four; or
M is four and a number of the first set of antenna ports with non-zero power is four, P is four and a number of the second antenna ports upon which signals were not sent is four, and N is eight.

11. The method of claim 8, wherein:
the first signals are first reference signals;
the second signals are second reference signals; and
receiving further comprises receiving the first reference signals with non-zero power in the first set M of N antenna ports and second reference signals with non-zero power, in the second set M of the N antenna ports, that are duplicates of the first reference signals, wherein duplication of the first reference signals on the second set of antenna ports creates at least in part the M-Tx codebook.

12. The method of claim 11, wherein searching comprises searching by the user equipment a subset that is less than all of the N-Tx codebook to determine a codeword to be fed back, wherein the subset of the codebook corresponds to the first set of antenna ports and not to the second set of antenna ports.

13. The method of claim 11, wherein one of the following is true:
M is two, a number of the first set of antenna ports with non-zero power is two, a number of the second antenna ports upon which signals were not sent is two, and N is four; or
M is four, a number of the first set of antenna ports with non-zero power is four, a number of the second antenna ports upon which signals were not sent is four, and N is eight.

14. The method of claim 8, wherein:
the method further comprises, prior to receiving, receiving one or more indications selecting which codebook indices in the N-Tx codebook should be searched by the user equipment, wherein the selected codebook indices are less than all of the indices in the N-Tx codebook; and
searching further comprises searching only the selected codebook indices in the N-Tx codebook to determine an N-Tx codeword to be fed back.

15. The method of claim 8, further comprising, after transmitting, receiving at the user equipment a transmission based on an M-Tx codeword that is a truncated version of the transmitted N-Tx codeword.

16. An apparatus, comprising:
one or more processors; and
one or more memories including computer program code,
the one or more memories and the computer program code configured, with the one or more processors, to cause the apparatus to perform at least the following:
applying a precoder to information to be transmitted on N antenna ports, wherein application of the precoder to the information creates at least in part an M-Tx codebook, each codeword of which is obtained through truncation of a transformed codeword from an N-Tx codebook corresponding to the N antenna ports:
transmitting the precoded information on the N antenna ports;
receiving, responsive to the transmission and from the user equipment, information allowing an N-Tx codeword to be selected from the N-Tx codebook:
truncating, based at least on the precoder, the N-Tx codeword to an M-Tx codeword; and
using the M-Tx codeword for a transmission of information to the user equipment.

17. The apparatus of claim 16, wherein:
the information comprise reference signals;
applying a precoder selects a first set of M of the N antenna ports to be energized during a transmission to a user equipment and a second set of P of the N antenna ports to not be energized during the transmission, N=M+P, wherein the antenna ports that are not energized create at least in part an M-Tx codebook, each codeword of which is obtained through truncation of a codeword from an N-Tx codebook corresponding to the N antenna ports;
transmitting further comprises transmitting reference signals with non-zero power on the first set of antenna ports and not transmitting signals on the second set of antenna ports;
receiving further comprises receiving, responsive to the transmission and from the user equipment, information allowing an N-Tx codeword to be selected from the N-Tx codebook; and
truncating further comprises truncating, based at least on the second set of P antenna ports, the N-Tx codeword to an M-Tx codeword.

18. The apparatus of claim 16, wherein:
the information comprise reference signals;
applying a precoder selects a first set of M of N antenna ports to transmit first reference signals during a transmission to a user equipment and a second set of M of the N antenna ports to duplicate the first reference signals during the transmission, wherein duplication of the first reference signals creates at least in part the M-Tx codebook;
transmitting further comprises transmitting the first reference signals with non-zero power on the first set of antenna ports and transmitting duplicate reference signals with non-zero power on the second set of antenna ports, and
receiving further comprises receiving, responsive to the transmission and from the user equipment, information allowing an N-Tx codeword to be selected from the N-Tx codebook; and
truncating further comprises truncating, based at least on the duplication of the first reference signals, the N-Tx codeword to an M-Tx codeword.

19. An apparatus, comprising:
one or more processors; and
one or more memories including computer program code,
the one or more memories and the computer program code configured, with the one or more processors, to cause the apparatus to perform at least the following:
receiving at a user equipment a transmission of first signals in a first set of N antenna ports and of second signals in a second set of the N antenna ports, wherein the second signals in the second set of antenna ports create at least in part an M-Tx codebook;
searching by the user equipment the N-Tx codebook to determine an N-Tx codeword to be fed back; and
transmitting by the user equipment information to allow the N-Tx codeword to be determined.

20. The apparatus of claim 19, wherein:
the first signals are reference signals;
receiving further comprises receiving reference signals with non-zero power in the first set of M of the N antenna ports and receiving the second signals in the second set of P of the N antenna ports upon which signals were not sent for the transmission, N M+P, wherein the P antenna ports upon which signals were not sent create at least in part the M-Tx codebook.

21. The apparatus of claim 19, wherein:
the first signals are first reference signals;
the second signals are second reference signals; and
receiving further comprises receiving the first reference signals with non-zero power in the first set M of N antenna ports and second reference signals with non-zero power, in the second set M of the N antenna ports, that are duplicates of the first reference signals, wherein duplication of the first reference signals on the second set of antenna ports creates at least in part the M-Tx codebook.
